(19) United States
(12) Patent Application Publication
(10) Pub. No.: US 2017/0032800 A1
(43) Pub. Date: Feb. 2, 2017

(54) ENCODING/DECODING AUDIO AND/OR SPEECH SIGNALS BY TRANSFORMING TO A DETERMINED DOMAIN

(71) Applicant: SAMSUNG ELECTRONICS CO., LTD., Suwon-si (KR)

(72) Inventors: Eun-mi OH, Seongnam-si (KR); Chang-youg SON, Gunpo-si (KR); Ki-hyun CHOO, Seoul (KR); Jung-hoe KIM, Seoul (KR)

(73) Assignee: SAMSUNG ELECTRONICS CO., LTD., Suwon-si (KR)

(21) Appl. No.: 15/294,112

(22) Filed: Oct. 14, 2016

Related U.S. Application Data
(63) Continuation of application No. 11/941,249, filed on Nov. 16, 2007, now abandoned.

(30) Foreign Application Priority Data
Nov. 17, 2006 (KR) 10-2006-0114102

(51) Int. Cl. G10L 19/20; G10L 19/032; G10L 19/02

(52) U.S. Cl. CPC G10L 19/20; G10L 19/0212; G10L 19/0204; G10L 19/032

(57) ABSTRACT

A method and apparatus to encode and/or decode a speech signal and/or an audio signal. The apparatus includes a first domain transforming unit, a frequency domain encoding unit, and a multiplexing unit to encode the speech signal and/or an audio signal. The apparatus includes a demultiplexing unit, a frequency domain decoding unit, and a second domain inverse transformation unit to decode the speech signal and/or the audio signal. The method and apparatus are capable of effectively encoding or decoding all of a speech signal, an audio signal, and a mixed signal of a speech signal and an audio signal, and improving the quality of sound by using a small number of bits.

### CROSS-REFERENCE TO RELATED APPLICATIONS

This application is a continuation application of U.S. patent application Ser. No. 11/941,249, filed on Nov. 16, 2007, which claims priority from Korean Patent Application No. 10-2006-0114102, filed on Nov. 17, 2006, in the Korean Intellectual Property Office, the disclosures of which are incorporated herein in its entirety by reference.

### BACKGROUND OF THE INVENTION

1. Field of the General Inventive Concept

The present general inventive concept relates to a codec, and more particularly, to a method and apparatus for encoding and decoding a speech signal and/or an audio signal.

2. Description of the Related Art

Conventional codecs are categorized into a speech codec and an audio codec. The speech codec is mainly used to encode or decode a signal corresponding to a frequency band ranging from 50 Hz to 7 kHz by using a speech utterance model. In general, the speech codec performs encoding and decoding by extracting parameters that represent a speech signal by modeling vocal cords and vocal intensities. The audio codec is mainly used to encode or decode a signal corresponding to a frequency band ranging from 0 Hz to 24 Hz by applying a psychoacoustic model, e.g., high-efficiency advanced audio coding (HE-AAC). The audio codec generally performs encoding and decoding by omitting low-sensitivity signals by using human auditory characteristics.

However, it is difficult to efficiently perform encoding and decoding of both a speech signal and an audio signal by using only one of the speech codec and the audio codec. The speech codec is suitable for encoding or decoding a speech signal but if it is used to encode or decode an audio signal, the quality of sound is degraded. If the audio codec is used to encode or decode an audio signal, the compression efficiency is good but if it is used to encode or decode a speech signal, the compression efficiency is degraded. Thus, there is a growing need for development of a method and apparatus for encoding or decoding a speech signal, an audio signal, or a mixed signal of a speech signal and an audio signal while improving the quality of sound with a small number of bits.

### SUMMARY OF THE GENERAL INVENTIVE CONCEPT

The present general inventive concept provides a method and apparatus to efficiently encode and/or decode a speech signal and/or an audio signal.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of encoding a signal, the method including transforming an input signal into at least one domain, determining a domain to be encoded using the input signal or the transformed signal in predetermined units, and encoding signals allocated to the units in the determined domain.

The foregoing and/or other aspects and utilities of the present general inventive concept may also be achieved by providing a method of encoding a signal, the method including determining one or more domains in which an input signal is to be encoded in predetermined units, and transforming signals allocated to the predetermined respective units into the determined domains, and then encoding the transformed signals.

The foregoing and/or other aspects and utilities of the present general inventive concept may also be achieved by providing a method of decoding a signal, the method including determining a plurality of domains in which signals for predetermined units have been respectively encoded, respectively decoding the signals in the determined domains, and restoring the original signal by mixing the decoded signals together.

The foregoing and/or other aspects and utilities of the present general inventive concept may also be achieved by providing an apparatus to encode a signal, including a transforming unit to transform an input signal into at least one domain and to determine a domain to be encoded using the input signal or the transformed signal in predetermined units, and an encoding unit to encode signals allocated to the units in the determined domain.

The foregoing and/or other aspects and utilities of the present general inventive concept may also be achieved by providing an apparatus to decode a signal, including a demultiplexing unit to determine a plurality of domains in which signals for predetermined units have been respectively encoded, and a decoding unit to respectively decode the signals in the determined domains, and a transforming unit to restore the original signal by mixing the decoded signals together.

The foregoing and/or other aspects and utilities of the present general inventive concept may also be achieved by providing an apparatus to encode and/or decode a signal, including an encoder to transform an input signal into at least one domain and to determine a domain to be encoded using the input signal or the transformed signal in predetermined units, and to encode signals allocated to the units in the determined domains, and a decoder to determine the determined domain in which the encoded signals are allocated, to respectively decode the signals in the determined domains, and to restore the input signal by mixing the decoded signals together.

The foregoing and/or other aspects and utilities of the present general inventive concept may also be achieved by providing a computer-readable medium containing computer-readable codes as a program to execute a method of transforming an input signal into at least one domain, determining a domain to be encoded using the input signal or the transformed signal in predetermined units, and encoding signals allocated to the units in the determined domain, and/or a method of determining a plurality of domains in which signals for predetermined units have been respectively encoded, respectively decoding the signals in the determined domains, and restoring the original signal by mixing the decoded signals together.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an audio and/or speech signal encoding apparatus according to an embodiment of the present general inventive concept;

FIG. 2 is a block diagram illustrating a frequency domain encoding unit included in the audio and/or speech signal encoding apparatus illustrated in FIG. 1, according to an embodiment of the present general inventive concept;

FIG. 3 is a block diagram illustrating the frequency domain encoding unit included in the audio and/or speech signal encoding apparatus illustrated in FIG. 1, according to another embodiment of the present general inventive concept;

FIG. 4 is a block diagram illustrating an audio and/or speech signal encoding apparatus according to another embodiment of the present general inventive concept;

FIG. 5 is a block diagram illustrating an audio and/or speech signal encoding apparatus according to another embodiment of the present general inventive concept;

FIG. 6 is a block diagram illustrating an audio and/or speech signal encoding apparatus according to another embodiment of the present general inventive concept;

FIG. 7 is a block diagram illustrating an audio and/or speech signal encoding apparatus according to another embodiment of the present general inventive concept;

FIG. 8 is a block diagram illustrating an audio and/or speech signal encoding apparatus according to another embodiment of the present general inventive concept;

FIG. 9 is a block diagram illustrating an audio and/or speech signal encoding apparatus according to another embodiment of the present general inventive concept;

FIG. 10 is a block diagram illustrating an audio and/or speech signal encoding apparatus according to another embodiment of the present general inventive concept;

FIG. 11 is a block diagram illustrating an audio and/or speech signal decoding apparatus according to an embodiment of the present general inventive concept;

FIG. 12 is a block diagram illustrating a frequency domain decoding unit included in the audio and/or speech signal encoding apparatus illustrated in FIG. 11, according to an embodiment of the present general inventive concept;

FIG. 13 is a block diagram illustrating a frequency domain decoding unit included in the audio and/or speech signal encoding apparatus illustrated in FIG. 11, according to another embodiment of the present general inventive concept;

FIG. 14 is a block diagram of an audio and/or speech signal decoding apparatus according to another embodiment of the present general inventive concept;

FIG. 15 is a block diagram of an audio and/or speech signal decoding apparatus according to another embodiment of the present general inventive concept;

FIG. 16 is a block diagram of an audio and/or speech signal decoding apparatus according to another embodiment of the present general inventive concept;

FIG. 17 is a block diagram of an audio and/or speech signal decoding apparatus according to another embodiment of the present general inventive concept;

FIG. 18 is a block diagram of an audio and/or speech signal decoding apparatus according to another embodiment of the present general inventive concept;

FIG. 19 is a block diagram of an audio and/or speech signal decoding apparatus according to another embodiment of the present general inventive concept;

FIG. 20 is a block diagram of an audio and/or speech signal decoding apparatus according to another embodiment of the present general inventive concept;

FIG. 21 is a flowchart illustrating an audio and/or speech signal encoding method according to an embodiment of the present general inventive concept;

FIG. 22 is a flowchart illustrating an operation of the encoding method illustrated in FIG. 21 according to an embodiment of the present general inventive concept;

FIG. 23 is a flowchart illustrating an operation of the encoding method illustrated in FIG. 21 according to another embodiment of the present general inventive concept;

FIG. 24 is a flowchart illustrating an audio and/or speech signal encoding method according to another embodiment of the present general inventive concept;

FIG. 25 is a flowchart illustrating an audio and/or speech signal encoding method according to another embodiment of the present general inventive concept;

FIG. 26 is a flowchart illustrating an audio and/or speech signal encoding method according to another embodiment of the present general inventive concept;

FIG. 27 is a flowchart illustrating an audio and/or speech signal encoding method according to another embodiment of the present general inventive concept;

FIG. 28 is a flowchart illustrating an audio and/or speech signal encoding method according to another embodiment of the present general inventive concept;

FIG. 29 is a flowchart illustrating an audio and/or speech signal encoding method according to another embodiment of the present general inventive concept;

FIG. 30 is a flowchart illustrating an audio and/or speech signal encoding method according to another embodiment of the present general inventive concept;

FIG. 31 is a flowchart illustrating an audio and/or speech signal decoding method according to an embodiment of the present general inventive concept;

FIG. 32 is a flowchart illustrating an operation of the decoding method illustrated in FIG. 31 according to an embodiment of the present general inventive concept;

FIG. 33 is a flowchart illustrating an operation of the decoding method illustrated in FIG. 31 according to another embodiment of the present general inventive concept;

FIG. 34 is a flowchart illustrating an audio and/or speech signal decoding method according to another embodiment of the present general inventive concept;

FIG. 35 is a flowchart illustrating an audio and/or speech signal decoding method according to another embodiment of the present general inventive concept;

FIG. 36 is a flowchart illustrating an audio and/or speech signal decoding method according to another embodiment of the present general inventive concept;

FIG. 37 is a flowchart illustrating an audio and/or speech signal decoding method according to another embodiment of the present general inventive concept;

FIG. 38 is a flowchart illustrating an audio and/or speech signal decoding method according to another embodiment of the present general inventive concept;

FIG. 39 is a flowchart illustrating an audio and/or speech signal decoding method according to another embodiment of the present general inventive concept; and

FIG. 40 is a flowchart illustrating an audio and/or speech signal decoding method according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

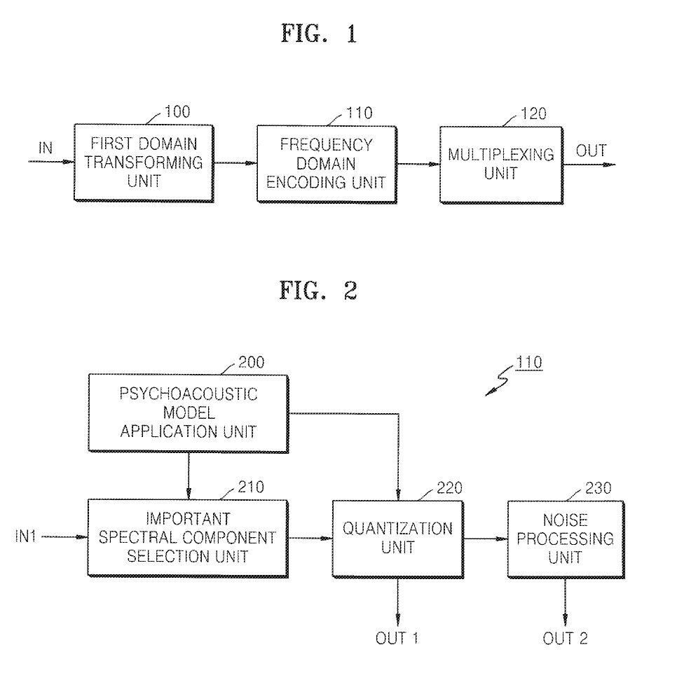

FIG. 1 is a block diagram of an audio and/or speech signal encoding apparatus according to an embodiment of the present general inventive concept. The encoding apparatus includes a first domain transformation unit 100, a frequency domain encoding unit 110 and a multiplexing unit 120.

The first domain transformation unit 100 transforms an input signal received via an input terminal IN from a time domain to a frequency domain and then divides the frequency band into sub bands. Here, the first domain transformation unit 100 transforms the input signal from the time domain to the frequency domain according to a first transformation method, and also transforms the input signal from the time domain to the frequency domain according to a second transformation method that is different from the first transformation method in order to apply a psychoacoustic model to the input signal. The signal transformed according to the first transformation method is used to encode the input signal, and the signal transformed according to the second transformation method is used in order to apply the psychoacoustic model to the input signal.

For example, the first domain transformation unit 100 may represent the input signal with real numbers by transforming it into the frequency domain by using Modified Discrete Cosine Transform (MDCT) as the first transformation method, and represent the input signal with imaginary numbers by transforming it into the frequency domain by using Modified Discrete Sine Transform (MDST) as the second transformation method. Here, the signal represented with real numbers as a result of using MDCT is used for encoding the input signal, and the signal represented with imaginary numbers as a result of using MDST is used for applying the psychoacoustic model to the input signal, together with the real numbers. Thus, since phase information of the input signal can be further represented, Discrete Fourier Transformation (DFT) is performed on the signal corresponding to the time domain and then MDCT coefficients are quantized, thereby preventing a mismatch from occurring.

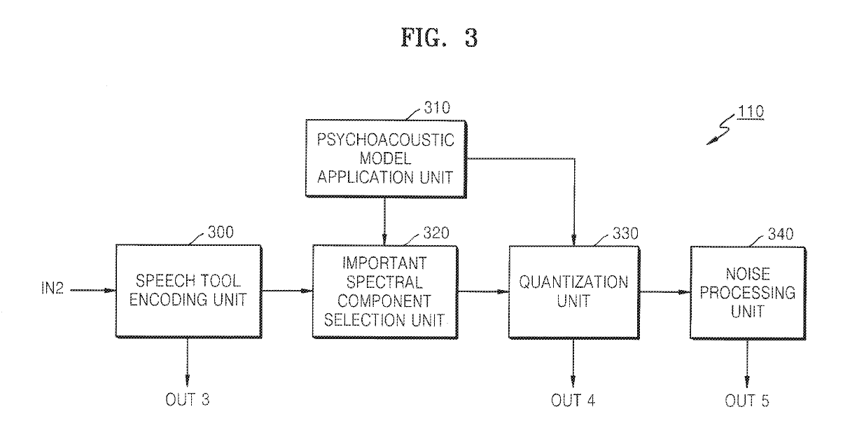

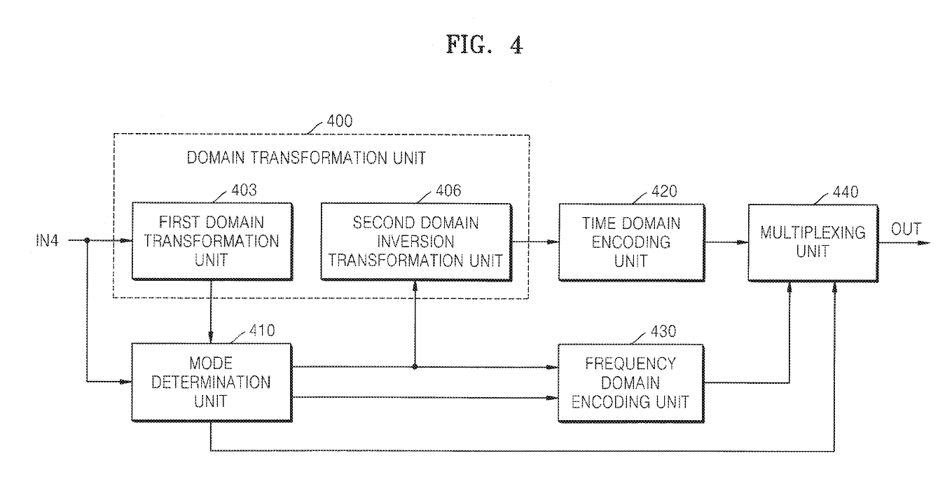

The frequency domain encoding unit 110 selects and quantizes an important spectral component from each of sub bands of the signal transformed by the first domain transformation unit 100 according to the first transformation method, and then extracts remnant spectral components, calculates and quantizes noise levels of the remnant spectral components. The frequency domain encoding unit 110 may be constructed as illustrated in FIG. 2 or 3.

FIG. 2 is a block diagram illustrating the frequency domain encoding unit 110 according to an embodiment of the present general inventive concept. Referring to FIGS. 1 and 2, the frequency domain encoding unit 110 includes a psychoacoustic model application unit 200, an important spectral component selection unit 210, a quantization unit 220, and a noise processing unit 230.

The psychoacoustic model application unit 200 applies the psychoacoustic model to an input signal in order to remove perceptual redundancy caused by human auditory characteristics. Here, the psychoacoustic model means a mathematical model regarding a masking reaction of a human auditory system.

The psychoacoustic model application unit 200 omits or excludes low-sensitivity particular information from the input signal by applying the psychoacoustic model using the human auditory system and allocates a signal-to-masking ratio (SMR) indicating the intensity of sensation in units of frequencies. The psychoacoustic model application unit 200 applies the psychoacoustic model by using the signal transformed according to the second transformation method. An example of the second transformation method is MDST.

The important spectral component selection unit 210 selects an important spectral component from each of sub bands of a signal that is represented in the frequency domain and received via an input terminal IN 1. In this case, the important spectral component selection unit 210 may use various methods in order to select an important spectral component. In a first method, the SMR of a signal is calculated and then the signal is determined as an important spectral component if the SMR is greater than a reciprocal number of a masking value. In a second method, an important spectral component is selected by extracting a spectrum peak in consideration of a predetermined weight. In a third method, a signal-to-noise ratio (SNR) of each of sub bands is calculated, and then a spectral component whose peak value is equal to or greater than a predetermined value is selected from among sub bands having a small SNR. The above three methods may be individually performed or one or a combination of at least two of the three methods may be performed.

The quantization unit 220 quantizes the important spectral component selected by the important spectral component selection unit 210 by using the SMR allocated by the psychoacoustic model application unit 200, and then outputs the quantized result via an output terminal OUT1.

The noise processing unit 230 extracts the remnant spectral components except the important spectral component selected by the important spectral component selection unit 210, from the signal represented in the frequency domain, which is received via the input terminal IN1, and then calculates and quantizes the noise levels of the remnant spectral components. Here, the noise processing unit 230 outputs the quantized result via an output terminal OUT2.

FIG. 3 is a block diagram illustrating the frequency domain encoding unit 110 according to another embodiment of the present general inventive concept. Referring to FIGS. 1 and 3, the frequency domain encoding unit 110 includes a speech tool encoding unit 300, a psychoacoustic model application unit 310, an important spectral component selection unit 320, a quantization unit 330 and a noise processing unit 340.

The speech tool encoding unit 300 finely encodes a signal that is determined as a strong attack signal having a critical value by dividing the signal into short transform lengths, and outputs a result at an output terminal OUT3. Here, the signal may be the signal transformed according to the first transformation method.

The psychoacoustic model application unit 310 applies the psychoacoustic model to an input signal in order to remove perceptual redundancy caused by the human auditory characteristics. Also, the psychoacoustic model application unit 310 calculates the number of bits allocated to the respective sub bands of a signal being represented in the frequency domain, which is received via an input terminal IN 2.

The psychoacoustic model application unit 310 omits or excludes low-sensitivity particular information from the input signal by applying the psychoacoustic model using the human auditory system, and allocates an SMR that indicates the intensity of sensation in units of frequencies while changing the SMR. The psychoacoustic model application unit 310 applies the psychoacoustic model by using the signal transformed according to the second transformation method. An example of the second transformation method is MDST.

The important spectral component selection unit 320 selects an important spectral component from each of sub bands of the signal being represented in the frequency domain, which is received via the input terminal IN 2. In this case, the important spectral component selection unit 320 may use various methods in order to select an important spectral component. First, the SMR of a signal is calculated and then the signal is determined as an important spectral component if the SMR is greater than a reciprocal number of a masking value. Second, an important spectral component is selected by extracting a spectrum peak in consideration of a predetermined weight. Third, a signal-to-noise ratio (SNR) of each of sub bands is calculated, and then a spectral component whose peak value is equal to or greater than a predetermined value is selected from among sub bands having a small SNR. The above three methods may be individually performed or one or a combination of at least two of the three methods may be performed.

The quantization unit 330 quantizes the important spectral component selected by the important spectral component selection unit 320 by using the SMR allocated by the psychoacoustic model application unit 310, and then outputs the quantized result via an output terminal OUT4.

The noise processing unit 340 extracts the remnant spectral components except the important spectral component selected by the important spectral component selection unit 320, from the signal represented in the frequency domain, which is received via the input terminal IN2, and then calculates and quantizes the noise levels of the remnant spectral components. Here, the noise processing unit 340 outputs the quantized result via an output terminal OUT5.

Here, the noise level may be calculated by performing the linear prediction analysis. The linear prediction analysis is performed using the autocorrelation method, but may be performed using the covariance method or the Durbin's method. Linear prediction allows an encoding unit to predict the amount of noise components present in a current frame. If more noise components are present, the remnant spectral components are directly transmitted without changing their noise levels. If less noise components are present and more tone components are present, the remnant spectral components are transmitted by reducing their noise levels. Also, in the case of using a small window indicating that noise rapidly changes, the remnant spectral components are directly transmitted by additionally reducing their noise levels.

The multiplexing unit 120 of FIG. 1 generates a bitstream by multiplexing the result of encoding by the frequency domain encoding unit 110, and outputs the bitstream via an output terminal OUT. Here, the result of encoding by the frequency domain encoding unit 110 means a result of encoding either the result of quantizing the important spectral component by the quantization unit 220 at the output terminal OUT1 and the result of quantizing the remnant spectral components by the noise processing unit 230 at the output terminal OUT2 (see FIG. 2), or the result of encoding by the speech tool encoding unit 300 at the output terminal OUT3, the result of quantizing the important spectral component by the quantization unit 330 at the output terminal OUT4, and the result of quantizing the remnant spectral components by the noise processing unit 340 at the output terminal OUT5 (see FIG. 3).

FIG. 4 is a block diagram illustrating an audio and/or speech signal encoding apparatus according to another embodiment of the present general inventive concept. The audio and/or speech signal encoding apparatus includes a domain transformation unit 400, a mode determination unit 410, a time domain encoding unit 420, a frequency domain encoding unit 430, and a multiplexing unit 440.

The domain transformation unit 400 transforms an input signal received via an input terminal IN4 from the time domain to the frequency domain, divides the signal in units of sub bands, and then inversely transforms a predetermined one or predetermined ones of the sub bands from the frequency band to the time domain.

The domain transformation unit 400 may be embodied to perform various transformation methods of receiving a signal represented in the time domain and representing the signal in both the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, the domain transformation unit 400 generates a signal to which the psychoacoustic model is to be applied, using imaginary numbers. An example of such a transformation method is Frequency Varying Modulated Lapped Transform (FV-MLT).

The domain transformation unit 400 includes a first domain transformation unit 403 and a second domain inversion transformation unit 406.

The first domain transformation unit 403 transforms the input signal received via the input terminal IN4 from the time domain to the frequency domain, and divides the signal in units of sub bands. Here, the first domain transformation unit 403 transforms the input signal from the time domain to the frequency domain according to a first transformation method, and also transforms the input signal from the time domain to the frequency domain according to a second transformation method that is different from the first transformation method in order to apply the psychoacoustic model to the input signal. The signal transformed according to the first transformation method is used to encode the input signal, and the signal transformed according to the second transformation method is used in order to apply the psychoacoustic model to the input signal.

For example, the first domain transformation unit 403 may represent the input signal with real numbers by transforming it into the frequency domain by using MDCT as the first transformation method, and represent the input signal with imaginary numbers by transforming it into the frequency domain by using MDST as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, DFT is performed on the signal corresponding to the time domain and then MDCT coefficients are quantized, thereby preventing a mismatch from occurring. The psychoacoustic model means a mathematical model regarding a masking reaction of the human auditory system.

The second domain inversion transformation unit 406 inversely transforms the predetermined sub bands, which are transformed into the frequency domain by the first domain transformation unit 403, from the frequency domain to the time domain according to an inverse transformation method of the first transformation method. For example, the second domain inversion transformation unit 406 performs Inverse Modified Discrete Cosine Transform (IMDCT) as the inverse transformation of the first transformation method.

The mode determination unit 410 determines whether it is appropriate to encode each of the sub bands of the signal transformed in the frequency domain by the first domain transformation unit 403, in the frequency domain. In other words, the mode determination unit 410 determines whether to encode each of the sub bands of the signal in the frequency domain or in the time domain, based on a predetermined basis. Also, the mode determination unit 410 quantizes an identifier indicating a domain being determined by the mode determination unit 410 for each of the sub bands and then outputs the quantized result to the multiplexing unit 440.

When the mode determination unit 410 determines whether to encode each of the sub bands in the frequency domain, either one of or both the signal that corresponds to the frequency domain and is received from the first domain transformation unit 403, and the signal that corresponds the time domain and is received via the input terminal IN4 may be used.

The second domain inversion transformation unit 406 inversely transforms a sub band from among the sub bands, which is determined not to be encoded in the frequency domain by the mode determination unit 410, from the frequency domain to the time domain according to the inverse transformation method of the first transformation method.

The time domain encoding unit 420 encodes one signal or more signals of the sub band being inversely transformed into the time domain by the second domain inversion transformation unit 406, in the time domain.

It is possible that the signal of the sub band being determined not to be encoded in the frequency domain can be not only encoded in the time domain by the time domain encoding unit 420 but also be encoded in the frequency domain by the frequency domain encoding unit 430. Thus a predetermined sub band(s) can be encoded in not only the time domain but also the frequency domain. In this case, an identifier representing that a signal of the predetermined sub band has been encoded in both the time domain and the frequency domain, is quantized and then the quantized result is output to the multiplexing unit 440.

The frequency domain encoding unit 430 encodes a sub band being determined to be encoded in the frequency domain by the mode determination unit 410, in the frequency domain. The frequency domain encoding unit 430 may be constructed as illustrated in FIG. 2 or 3.

The multiplexing unit 440 multiplexes the result of quantizing the identifier representing the domain in which each of the sub bands has been encoded, the result of encoding by the time domain encoding unit 420, and the result of encoding by the frequency domain encoding unit 430 in order to generate a bitstream, and then outputs the bitstream via the output terminal OUT. Here, the result of encoding by the frequency domain encoding unit 430 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

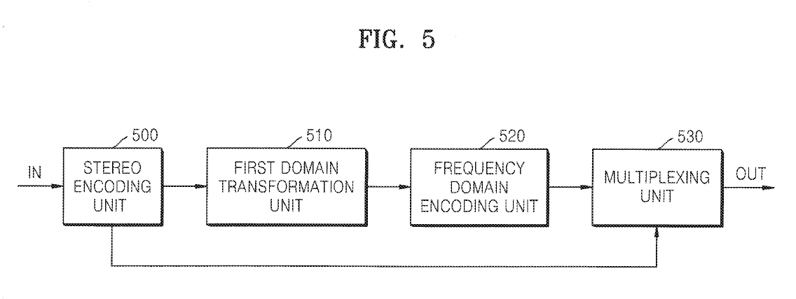

FIG. 5 is a block diagram illustrating an audio and/or speech signal encoding apparatus according to another embodiment of the present general inventive concept. The audio and/or speech signal encoding apparatus includes a stereo encoding unit 500, a first domain transformation unit 510, a frequency domain encoding unit 520 and a multiplexing unit 530.

If an input signal received via an input terminal IN is a stereo signal, the stereo encoding unit 500 extracts parameters by analyzing the input signal and then down-mixes the input signal. The extracted parameters are information needed for a decoding terminal to upmix a mono signal received from an encoding terminal to a stereo signal. Examples of the parameters include the difference between the energy levels of two channels, or the correlation or coherence between two channels. The stereo encoding unit 500 quantizes the parameters and then outputs the quantized result to the multiplexing unit 530.

The first domain transformation unit 510 transforms the signal being downmixed by the stereo encoding unit 500 from the time domain to the frequency domain, and then divides the signal in units of sub bands. Here, the first domain transformation unit 510 transforms the downmixed signal from the time domain to the frequency domain according to a first transformation method, and also transforms the input signal from the time domain to the frequency domain according to a second transformation method that is different from the first transformation method in order to apply the psychoacoustic model to the input signal. The signal transformed according to the first transformation method is used to encode the input signal, and the signal transformed according to the second transformation method is used in order to apply the psychoacoustic model to the input signal. The psychoacoustic model means a mathematical model regarding a masking reaction of the human auditory system.

For example, the first domain transformation unit 510 may represent the input signal with real numbers by transforming it into the frequency domain by using Modified Discrete Cosine Transform (MDCT) as the first transformation method, and represent the input signal with imaginary numbers by transforming it into the frequency domain by using Modified Discrete Sine Transform (MDST) as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, Discrete Fourier Transformation (DFT) is performed on the signal corresponding to the time domain and then MDCT coefficients are quantized, thereby preventing a mismatch from occurring.

The frequency domain encoding unit 520 selects and quantizes an important spectral component from each of sub bands of the signal transformed by the first domain transformation unit 500 according to the first transformation method, and then extracts the remnant spectral components, calculates and quantizes the noise levels of the remnant spectral components. The frequency domain encoding unit 520 may be constructed as illustrated in FIG. 2 or 3.

The multiplexing unit 530 multiplexes the parameters quantized by the stereo encoding unit 500 and the result of encoding by the frequency domain encoding unit 520 in order to generate a bitstream, and then outputs the bitstream via an output terminal OUT. Here, the result of encoding by the frequency domain encoding unit 520 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

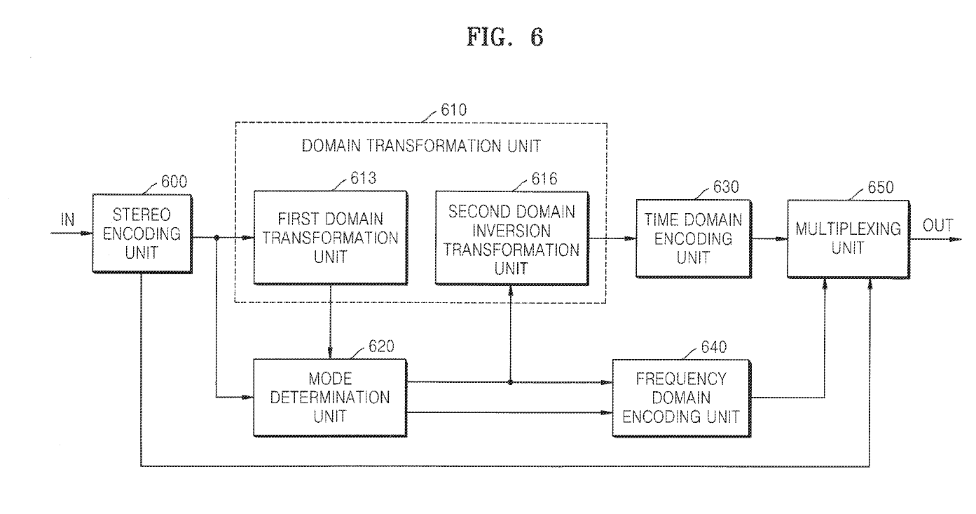

FIG. 6 is a block diagram illustrating an audio and/or speech signal encoding apparatus according to another embodiment of the present general inventive concept. The audio and/or speech signal encoding apparatus includes a stereo encoding unit 600, a domain transformation unit 610, a mode determination unit 620, a time domain encoding unit 630, a frequency domain encoding unit 640 and a multiplexing unit 650.

If an input signal received via an input terminal IN is a stereo signal, the stereo encoding unit 600 extracts parameters by analyzing the input signal and then down-mixes the input signal. The extracted parameters are information needed for a decoding terminal to upmix a mono signal received from an encoding terminal to a stereo signal. Examples of the parameters include the difference between the energy levels of two channels, or the correlation or coherence between two channels. The stereo encoding unit 600 quantizes the parameters and then outputs the quantized result to the multiplexing unit 650.

The domain transformation unit 610 transforms the signal being downmixed by the stereo encoding unit 600 from the time domain to the frequency domain, divides the signal in units of sub bands, and inversely transforms a predetermined one or predetermined ones of the sub bands.

Here, the domain transformation unit 610 may be embodied to perform various transformation methods of receiving a signal represented in the time domain and representing the signal in both the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, the domain transformation unit 610 generates a signal to which the psychoacoustic model is to be applied, using imaginary numbers. An example of such a transformation method is Frequency-Varying Modulated Lapped Transform (FV-MLT).

The domain transformation unit 610 includes a first domain transformation unit 613 and a second domain inverse transformation unit 616.

The first domain transformation unit 613 transforms the signal being downmixed by the stereo encoding unit 600 from the time domain to the frequency domain, and then divides the signal in units of sub bands. Here, the first domain transformation unit 613 transforms the downmixed signal from the time domain to the frequency domain according to a first transformation method, and also transforms the input signal from the time domain to the frequency domain according to a second transformation method that is different from the first transformation method in order to apply the psychoacoustic model to the input signal. The signal transformed according to the first transformation method is used to encode the downmixed signal, and the signal transformed according to the second transformation method is used in order to apply the psychoacoustic model to the downmixed signal.

For example, the first domain transformation unit 613 may represent the downmixed signal with real numbers by transforming it into the frequency domain by using MDCT as the first transformation method, and represent the input signal with imaginary numbers by transforming it into the frequency domain by using MDST as the second transformation method. Here, the signal represented with real numbers as a result of using MDCT is used for encoding the downmixed signal, and the signal represented with imaginary numbers as a result of using MDST is used for applying the psychoacoustic model to the downmixed signal. Thus, since phase information of the input signal can be further represented, Discrete Fourier Transformation (DFT) is performed on the signal corresponding to the time domain and then MDCT coefficients are quantized, thereby preventing a mismatch from occurring.

The second domain inverse transformation unit 616 inversely transforms predetermined sub bands, which are transformed into the frequency domain by the first domain transformation unit 613, from the frequency domain to the time domain according to an inverse transformation method of the first transformation method. For example, the second domain inversion transformation unit 616 performs IMDCT as the inverse transformation of the first transformation method.

The mode determination unit 620 determines whether it is appropriate to encode each of the sub bands of the signal transformed in the frequency domain by the first domain transformation unit 613, in the frequency domain. In other words, the mode determination unit 620 determines whether to encode each of the sub bands of the signal in the frequency domain or in the time domain. Also, the mode determination unit 620 quantizes an identifier indicating a domain being determined by the mode determination unit 620 for each of the sub bands and then outputs the quantized result to the multiplexing unit 650.

When the mode determination unit 620 determines whether to encode each of the sub bands in the frequency domain, either one of or both the signal that corresponds to the frequency domain and is received from the first domain transformation unit 613, and the signal that corresponds the time domain and is received from the stereo encoding unit 600 may be used.

The second domain inverse transformation unit 616 inversely transforms a sub band from among the sub bands, which is determined not to be encoded in the frequency domain by the mode determination unit 620, from the frequency domain to the time domain according to the inverse transformation method of the first transformation method. For example, the second domain inverse transformation unit 616 inversely transforms the sub band into the time domain by performing IMDCT thereon.

The time domain encoding unit 630 encodes one or more signals of the sub band being inversely transformed into the time domain by the second domain inversion transformation unit 616, in the time domain.

It is possible that the signal of the sub band being determined not to be encoded in the frequency domain can be not only encoded in the time domain by the time domain encoding unit 630 but also be encoded in the frequency domain by the frequency domain encoding unit 640. Thus a predetermined sub band(s) can be encoded in not only the time domain but also the frequency domain. In this case, an identifier representing that a signal of the predetermined sub band has been encoded in both the time domain and the frequency domain, is quantized and then the quantized result is output to the multiplexing unit 650.

The frequency domain encoding unit 640 encodes a sub band being determined to be encoded in the frequency domain by the mode determination unit 620, in the frequency domain. The frequency domain encoding unit 640 may be constructed as illustrated in FIG. 2 or 3.

The multiplexing unit 650 multiplexes the parameters quantized by the stereo encoding unit 600, the result of quantizing the identifier representing the domain in which each of the sub bands has been encoded, the result of encoding by the time domain encoding unit 630, and the result of encoding by the frequency domain encoding unit 640 in order to generate a bitstream, and then outputs the bitstream via the output terminal OUT. Here, the result of encoding by the frequency domain encoding unit 640 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

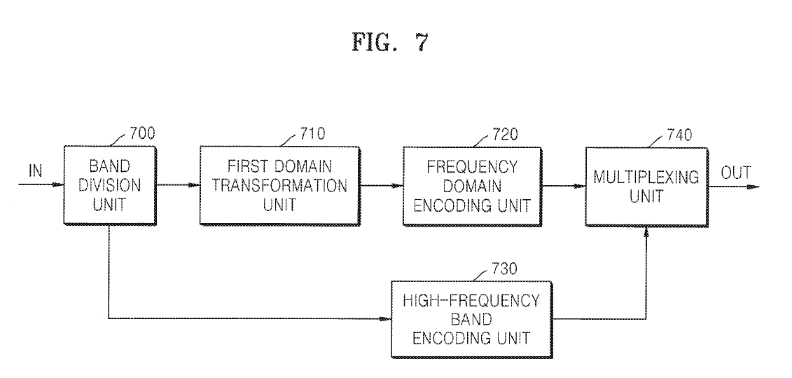

FIG. 7 is a block diagram illustrating an audio and/or speech signal according to another embodiment of the present general inventive concept. The audio and/or speech signal encoding apparatus includes a band division unit 700, a first domain transformation unit 710, a frequency domain encoding unit 720, a high-frequency band encoding unit 730, and a multiplexing unit 740.

The band division unit 700 divides an input signal received via an input terminal IN into a low-frequency band signal and a high-frequency band signal, based on a predetermined frequency.

The first domain transformation unit 710 transforms the low-frequency band signal received from the band division unit 700 from the time domain to the frequency domain, and then divides the low-frequency signal in units of sub bands. Here, the first domain transformation unit 710 transforms the low-frequency band signal from the time domain to the frequency domain according to a first transformation method, and also transforms the low-frequency band signal from the time domain to the frequency domain according to a second transformation method that is different from the first transformation method in order to apply the psychoacoustic model to the low-frequency band signal. The signal transformed according to the first transformation method is used to encode the low-frequency band signal, and the signal transformed according to the second transformation method is used in order to apply the psychoacoustic model to the low-frequency band signal. The psychoacoustic model means a mathematical model regarding a masking reaction of the human auditory system.

For example, the first domain transformation unit 710 may represent the low-frequency band signal with real numbers by transforming it into the frequency domain by using MDCT as the first transformation method, and represent the low-frequency band signal with imaginary numbers by transforming it into the frequency domain by using MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring.

The frequency domain encoding unit 720 selects and quantizes an important spectral component from each of sub bands of the signal that is represented in the frequency domain and received from the first domain transformation unit 710, and then extracts the remnant spectral components, calculates and quantizes the noise levels of the remnant spectral components. The frequency domain encoding unit 720 may be constructed as illustrated in FIG. 2 or 3.

The high-frequency band encoding unit 730 encodes the high-frequency band signal received from the band division unit 700, using the low-frequency band signal.

The multiplexing unit 740 multiplexes the result of encoding by the frequency domain encoding unit 720 and the result of encoding by the high-frequency band encoding unit 730 in order to generate a bitstream, and then outputs the bitstream via an output terminal OUT. Here, the result of encoding by the frequency domain encoding unit 720 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

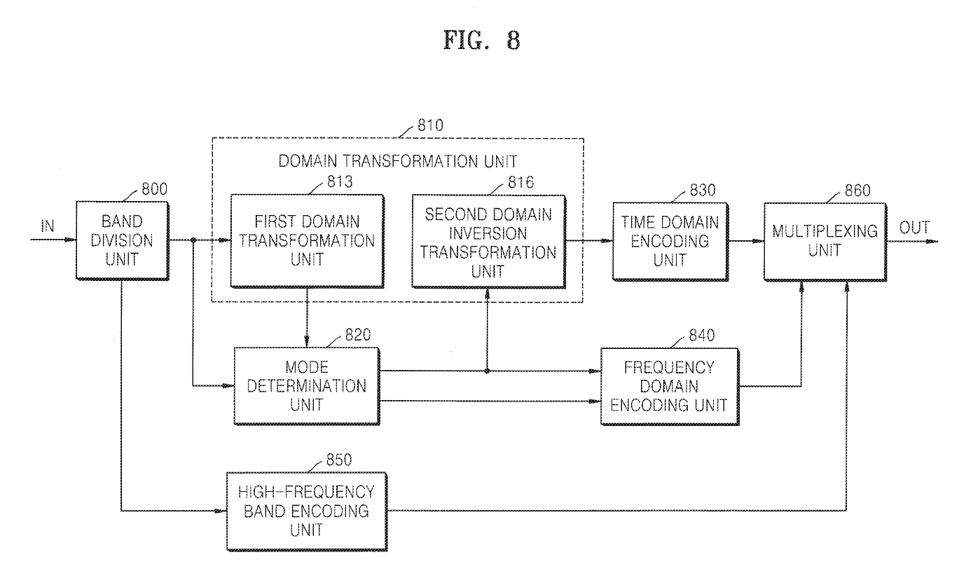

FIG. 8 is a block diagram illustrating an audio and/or speech signal encoding apparatus according to another embodiment of the present general inventive concept. The audio and/or speech signal encoding apparatus includes a band division unit 800, a domain transformation unit 810, a mode determination unit 820, a time domain encoding unit 830, a frequency domain encoding unit 840, a high-frequency band encoding unit 850 and a multiplexing unit 860.

The band division unit 800 divides an input signal received from an input terminal IN into a low-frequency band signal and a high-frequency band signal, based on a predetermined frequency.

The domain transformation unit 810 transforms the low-frequency band signal received from the band division unit 800 from the time domain to the frequency domain, divides the low-frequency signal in units of sub bands, and inversely transforms a predetermined one or predetermined ones of the sub bands into the time domain.

Here, the first domain transformation unit 813 may be embodied to perform various transformation methods of receiving a signal represented in the time domain and representing the signal in both the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, the domain transformation unit 810 generates a signal to which the psychoacoustic model is to be applied, using imaginary numbers. An example of such a transformation method is FV-MLT.

The domain transformation unit 810 includes a first domain transformation unit 813 and a second domain inverse transformation unit 816.

The first domain transformation unit 813 transforms the low-frequency band signal received from the band division unit 700 from the time domain to the frequency domain, and then divides the low-frequency signal in units of sub bands. Here, the first domain transformation unit 813 transforms the low-frequency band signal from the time domain to the frequency domain according to a first transformation method, and also transforms the low-frequency band signal from the time domain to the frequency domain according to a second transformation method that is different from the first transformation method in order to apply the psychoacoustic model to the low-frequency band signal. The signal transformed according to the first transformation method is used to encode the low-frequency band signal, and the signal transformed according to the second transformation method is used in order to apply the psychoacoustic model to the low-frequency band signal.

For example, the first domain transformation unit 813 may represent the low-frequency band signal with real numbers by transforming it into the frequency domain by using MDCT as the first transformation method, and represent the low-frequency band signal with imaginary numbers by transforming it into the frequency domain by using MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring.

The second domain inverse transformation unit 816 inversely transforms a predetermined one or predetermined ones of the sub bands transformed into the frequency domain by the first domain transformation unit 813, from the frequency domain to the time domain according to an inverse transformation method of the first transformation method. For example, the second domain inverse transformation unit 816 performs IMDCT as the inverse transformation method of the first transformation method.

The mode determination unit 820 determines whether it is appropriate to encode each of the sub bands of the low-frequency band signal transformed in the frequency domain by the first domain transformation unit 813, in the frequency domain. In other words, the mode determination unit 820 determines whether to encode each of the sub bands of the low-frequency band signal in the frequency domain or in the time domain. Also, the mode determination unit 820 quantizes an identifier indicating a domain being determined by the mode determination unit 820 for each of the sub bands and then outputs the quantized result to the multiplexing unit 860.

When the mode determination unit 820 determines whether to encode each of the sub bands in the frequency domain, either one of or both the signal that corresponds to the frequency domain and is received from the first domain transformation unit 813, and the signal that corresponds the time domain and is received from the band division unit 800 may be used.

The second domain inverse transformation unit 816 inversely transforms a sub band from among the sub bands, which is determined not to be encoded in the frequency domain by the mode determination unit 820, from the frequency domain to the time domain according to the inverse transformation method of the first transformation method. For example, the second domain inverse transformation unit 816 inversely transforms the sub band from the frequency domain to the time domain by performing IMDCT thereon.

The time domain encoding unit 830 encodes one or more signals of the sub band being inversely transformed into the time domain by the second domain inversion transformation unit 816, in the time domain.

In a predetermined one or predetermined ones cases, the signal of the sub band being determined not to be encoded in the frequency domain can be not only encoded in the time domain by the time domain encoding unit 830 but also be encoded in the frequency domain by the frequency domain encoding unit 840. Thus a predetermined sub band(s) can be encoded in not only the time domain but also the frequency domain. In this case, an identifier representing that a signal of the predetermined sub band has been encoded in both the time domain and the frequency domain, is quantized and then the quantized result is output to the multiplexing unit 860.

The frequency domain encoding unit 840 encodes a sub band being determined to be encoded in the frequency domain by the mode determination unit 820, in the frequency domain. The frequency domain encoding unit 840 may be constructed as illustrated in FIG. 2 or 3.

The high-frequency band encoding unit 850 encodes the high-frequency band signal received from the band division unit 800 by using the low-frequency band signal.

The multiplexing unit 860 multiplexes the result of quantizing the identifier indicating the domain in which each of the sub bands has been encoded, the result of encoding by the time domain encoding unit 830, the result of encoding by the frequency domain encoding unit 840, and the result of encoding by the high-frequency band encoding unit 850 in order to generate a bitstream, and then outputs the bitstream via the output terminal OUT. Here, the result of encoding by the frequency domain encoding unit 840 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

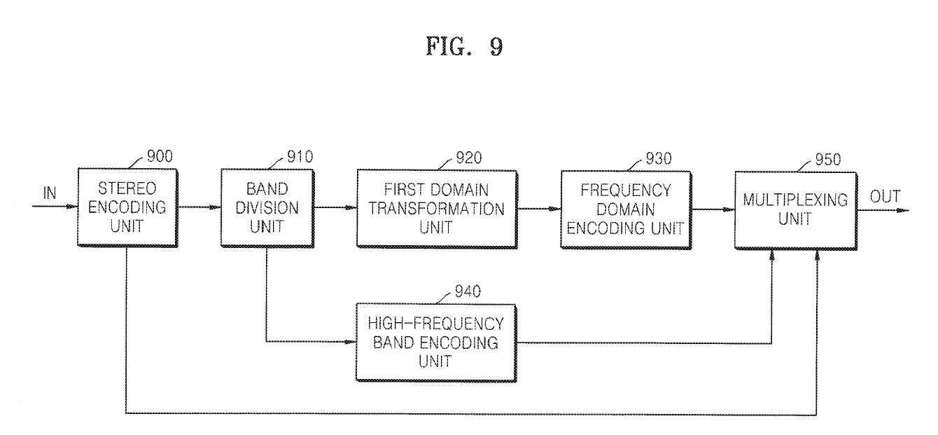

FIG. 9 is a block diagram illustrating an audio and/or speech signal encoding apparatus according to another embodiment of the present general inventive concept. The audio and/or speech signal encoding apparatus includes a stereo encoding unit 900, a band division unit 910, a first domain transformation unit 920, a frequency domain encoding unit 930, a high-frequency band encoding unit 940 and a multiplexing unit 950.

If an input signal received via an input terminal IN is a stereo signal, the stereo encoding unit 900 extracts parameters by analyzing the input signal and then down-mixes the input signal. The extracted parameters are information needed for a decoding terminal to upmix a mono signal received from an encoding terminal to a stereo signal. Examples of the parameters include the difference between the energy levels of two channels, or the correlation or coherence between two channels. The stereo encoding unit 900 quantizes the parameters and then outputs the quantized result to the multiplexing unit 950.

The band division unit 910 divides the signal downmixed by the stereo encoding unit 900 into a low-frequency band signal and a high-frequency band signal, based on a predetermined frequency.

The first domain transformation unit 920 transforms the low-frequency band signal received from the band division unit 910 from the time domain to the frequency domain, and then divides the signal in units of sub bands. Here, the first domain transformation unit 920 transforms the low-frequency band signal from the time domain to the frequency domain according to a first transformation method, and also transforms the low-frequency band signal from the time domain to the frequency domain according to a second transformation method that is different from the first transformation method in order to apply the psychoacoustic model to the low-frequency band signal. The signal transformed according to the first transformation method is used to encode the low-frequency band signal, and the signal transformed according to the second transformation method is used in order to apply the psychoacoustic model to the low-frequency band signal. The psychoacoustic model means a mathematical model regarding a masking reaction of the human auditory system.

For example, the first domain transformation unit 920 may represent the low-frequency band signal with real numbers by transforming it into the frequency domain by using MDCT as the first transformation method, and represent the low-frequency band signal with imaginary numbers by transforming it into the frequency domain by using MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, Discrete Fourier Transformation (DFT) is performed on the signal corresponding to the time domain and then MDCT coefficients are quantized, thereby preventing a mismatch from occurring.

The frequency domain encoding unit 930 selects and quantizes an important spectral component from each of sub bands of the signal that is represented in the frequency domain and received from the first domain transformation unit 920, and then extracts the remnant spectral components, calculates and quantizes the noise levels of the remnant spectral components. The frequency domain encoding unit 930 may be constructed as illustrated in FIG. 2 or 3.

The high-frequency band encoding unit 940 encodes the high-frequency band signal received from the band division unit 910, using the low-frequency band signal.

The multiplexing unit 950 multiplexes the parameters quantized by the stereo encoding unit 900, the result of encoding by the frequency domain encoding unit 930 and the result of encoding by the high-frequency band encoding unit 940 in order to generate a bitstream, and then outputs the bitstream via an output terminal OUT. Here, the result of encoding by the frequency domain encoding unit 930 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

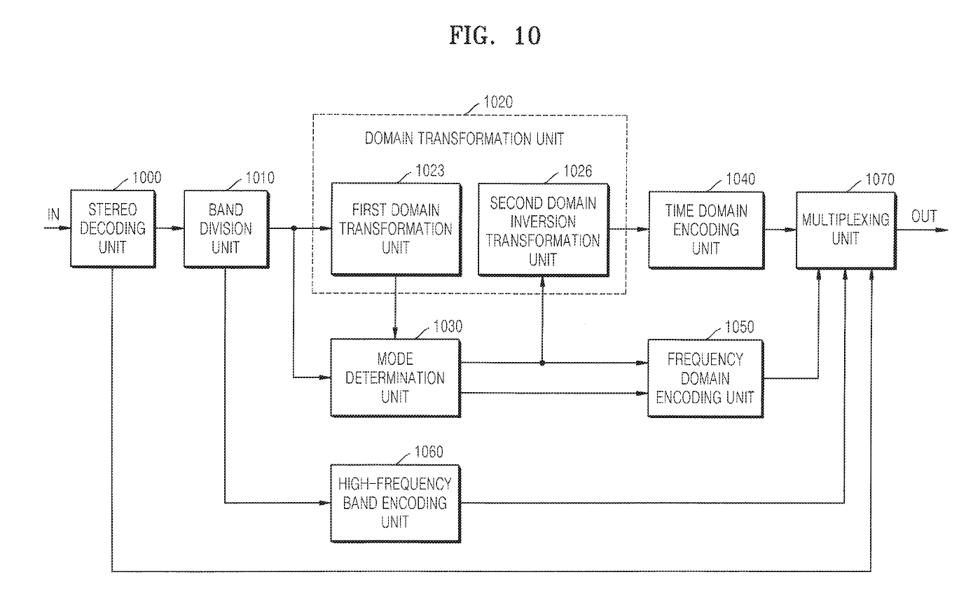

FIG. 10 is a block diagram illustrating an audio and/or speech signal encoding apparatus according to another embodiment of the present general inventive concept. The audio and/or speech signal encoding apparatus includes a stereo encoding unit 1000, a band division unit 1010, a domain transformation unit 1020, a mode determination unit 1030, a time domain encoding unit 1040, a frequency domain encoding unit 1050, a high-frequency band encoding unit 1060 and a multiplexing unit 1070.

If an input signal received via an input terminal IN is a stereo signal, the stereo encoding unit 1000 extracts parameters by analyzing the input signal and then down-mixes the input signal. The extracted parameters are information needed for a decoding terminal to upmix a mono signal received from an encoding terminal to a stereo signal. Examples of the parameters include the difference between the energy levels of two channels, or the correlation or coherence between two channels. The stereo encoding unit 1000 quantizes the parameters and then outputs the quantized result to the multiplexing unit 1070.

The band division unit 1010 divides the signal downmixed by the stereo encoding unit 1000 into a low-frequency band signal and a high-frequency band signal, based on a predetermined frequency.

The domain transformation unit 1020 transforms the low-frequency band signal received from the band division unit 1010 from the time domain to the frequency domain, divides the signal in units of sub bands, and inversely transforms a predetermined one or predetermined ones of the sub bands in the time domain.

Here, the domain transformation unit 1020 may be embodied to perform various transformation methods of receiving a signal represented in the time domain and representing the signal in both the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, the domain transformation unit 1020 generates a signal to which the psychoacoustic model is to be applied, using imaginary numbers. An example of such a transformation method is FV-MLT.

The domain transformation unit 1020 includes a first domain transformation unit 1023 and a second domain inverse transformation unit 1026.

The first domain transformation unit 1023 transforms the low-frequency band signal received from the band division unit 1010 from the time domain to the frequency domain, and then divides the signal in units of sub bands. Here, the first domain transformation unit 1023 transforms the low-frequency band signal from the time domain to the frequency domain according to a first transformation method, and also transforms the low-frequency band signal from the time domain to the frequency domain according to a second transformation method that is different from the first transformation method in order to apply the psychoacoustic model to the low-frequency band signal. The signal transformed according to the first transformation method is used to encode the low-frequency band signal, and the signal transformed according to the second transformation method is used in order to apply the psychoacoustic model to the low-frequency band signal. The psychoacoustic model means a mathematical model regarding a masking reaction of the human auditory system.

For example, the first domain transformation unit 1023 may represent the low-frequency band signal with real numbers by transforming it into the frequency domain by using MDCT as the first transformation method, and represent the low-frequency band signal with imaginary numbers by transforming it into the frequency domain by using MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring.

The second domain inverse transformation unit 1026 inversely transforms a predetermined one or predetermined ones of the sub bands transformed into the frequency domain by the first domain transformation unit 1023, from the frequency domain to the time domain according to an inverse transformation method of the first transformation method. For example, the second domain inverse transformation unit 1026 performs IMDCT as the inverse transformation method of the first transformation method.

The mode determination unit 1030 determines whether it is appropriate to encode each of the sub bands of the low-frequency band signal transformed in the frequency domain by the first domain transformation unit 1023, in the frequency domain. In other words, the mode determination unit 1030 determines whether to encode each of the sub bands of the low-frequency band signal in the frequency domain or in the time domain. Also, the mode determination unit 1030 quantizes an identifier indicating a domain being determined by the mode determination unit 1030 for each of the sub bands and then outputs the quantized result to the multiplexing unit 1070.

When the mode determination unit 1030 determines whether to encode each of the sub bands in the frequency domain, either one of or both the signal that corresponds to the frequency domain and is received from the first domain transformation unit 1023, and the signal that corresponds the time domain and is received from the band division unit 1010 may be used.

The second domain inverse transformation unit 1026 inversely transforms a sub band from among the sub bands, which is determined not to be encoded in the frequency domain by the mode determination unit 1030, from the frequency domain to the time domain according to the inverse transformation method of the first transformation method. For example, the second domain inverse transformation unit 1026 inversely transforms the sub band by performing IMDCT thereon.

The time domain encoding unit 1040 encodes one or more signals of the sub band being inversely transformed into the time domain by the second domain inversion transformation unit 1026, in the time domain.

It is possible that the signal of the sub band being determined not to be encoded in the frequency domain can be not only encoded in the time domain by the time domain encoding unit 1040 but also be encoded in the frequency domain by the frequency domain encoding unit 1050. Thus a predetermined sub band(s) can be encoded in not only the time domain but also the frequency domain. In this case, an identifier representing that a signal of the predetermined sub band has been encoded in both the time domain and the frequency domain, is quantized and then the quantized result is output to the multiplexing unit 1070.

The frequency domain encoding unit 1050 encodes a sub band being determined to be encoded in the frequency domain by the mode determination unit 1030, in the frequency domain. The frequency domain encoding unit 1050 may be constructed as illustrated in FIG. 2 or 3.

The high-frequency band encoding unit 1060 encodes the high-frequency band signal received from the band division unit 1010 by using the low-frequency band signal.

The multiplexing unit 1070 multiplexes the parameters quantized by the stereo encoding unit 1000 the result of quantizing the identifier indicating the domain in which each of the sub bands has been encoded, the result of encoding by the time domain encoding unit 1040, the result of encoding by the frequency domain encoding unit 1050, and the result of encoding by the high-frequency band encoding unit 1060 in order to generate a bitstream, and then outputs the bitstream via the output terminal OUT. Here, the result of encoding by the frequency domain encoding unit 1050 means either the result of quantizing the important spectral component by the quantization unit 220 and the result of quantizing the remnant spectral components by the noise processing unit 230 (see FIG. 2), or the result of encoding by the speech tool encoding unit 300, the result of quantizing the important spectral component by the quantization unit 330, and the result of quantizing the remnant spectral components by the noise processing unit 340 (see FIG. 3).

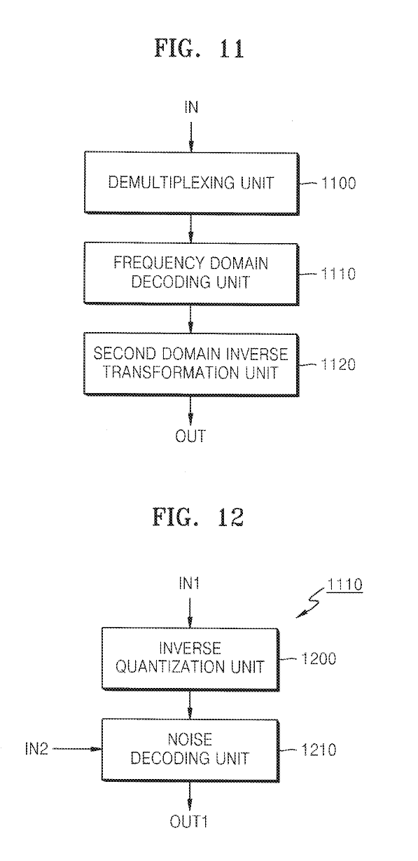

FIG. 11 is a block diagram illustrating an audio and/or speech signal decoding apparatus according to an embodiment of the present general inventive concept. The audio and/or speech signal decoding apparatus includes a demultiplexing unit 1100, a frequency domain decoding unit 1110 and a second domain inverse transformation unit 1120.

The demultiplexing unit 1100 receives a bitstream from an encoding terminal (not shown) via an input terminal IN and demultiplexes the bitstream. Here, the result of demultiplexing the bitstream output from the demultiplexing unit 1100 includes the result of quantizing an important spectral component being encoded in the frequency domain by the encoding terminal, and the result of quantizing the noise levels of the remnant spectral components. In addition, the result of demultiplexing the bitstream may further include the result of encoding using a speech tool.

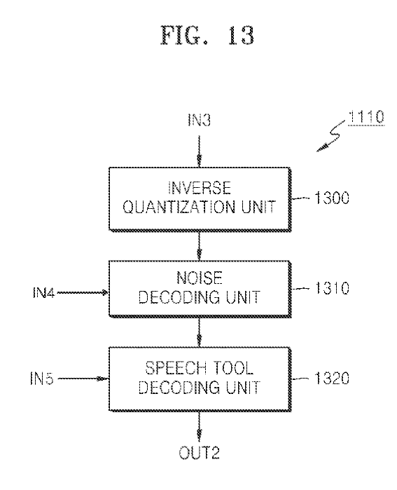

The frequency domain decoding unit 1110 decodes the result of encoding by the encoding terminal in the frequency domain, which is received from the demultiplexing unit 1100. More specifically, the frequency domain decoding unit 1110 decodes an important spectral component selected from each of sub bands, and the noise levels of the remnant spectral components. The frequency domain decoding unit 1110 may be constructed as illustrated in FIG. 12 or 13.

FIG. 12 is a block diagram illustrating the frequency domain decoding unit 1110 of the audio and/or speech signal decoding apparatus of FIG. 11 according to an embodiment of the present general inventive concept. The frequency domain decoding unit 1110 includes an inverse quantization unit 1200 and a noise decoding unit 1210.

The inverse quantization unit 1200 receives the result of demultiplexing important spectral components, which are respectively encoded with different numbers of bits allocated by applying the psychoacoustic model that removes perceptual redundancy caused by the human auditory characteristics, via an input terminal IN1, and then demultiplexes it. Here, the psychoacoustic model means a mathematical model regarding a masking reaction of the human auditory system.

The noise decoding unit 1210 receives the result of demultiplexing the noise levels of the remnant spectral components except the important spectral components via an input terminal IN2, and then decodes them. Also, the noise decoding unit 1210 combines the decoded noise levels with the important spectral components being inversely quantized by the inverse quantization unit 1200. The noise decoding unit 1210 outputs the combined result via an output terminal OUT1.

FIG. 13 is a block diagram illustrating the frequency domain decoding unit 1110 of the audio and/or speech signal decoding apparatus of FIG. 11 according to another embodiment of the present general inventive concept. The frequency domain decoding unit 1110 includes an inverse quantization unit 1300, a noise decoding unit 1310, and a speech tool decoding unit 1320.

The inverse quantization unit 1300 receives the result of demultiplexing important spectral components, which are respectively encoded with different numbers of bits allocated by applying the psychoacoustic model that removes perceptual redundancy caused by the human auditory characteristics, via an input terminal IN3, and then demultiplexes it.

The noise decoding unit 1310 receives the result of demultiplexing the noise levels of the remnant spectral components except the important spectral components via an input terminal IN4, and then decodes them. Also, the noise decoding unit 1310 combines the decoded noise levels with the important spectral components being inversely quantized by the inverse quantization unit 1300.

The speech tool decoding unit 1320 receives the result of encoding by an encoding terminal (not shown) by using a speech tool via an input terminal IN5, and then decodes it. Also, the speech tool decoding unit 1320 combines the result of decoding by the speech tool decoding unit 1320 with the result of combining by the noise decoding unit 1310. Here, the speech tool decoding unit 1320 outputs the combined result via an output terminal OUT2.

Referring to FIG. 11, the second domain inverse transformation unit 1120 inversely transforms the result of decoding by the frequency domain decoding unit 1110 from the frequency domain to the time domain according to a second inversion transformation method. Here, the second inversion transformation method is an inverse operation of the above second transformation method. An example of the second inversion transformation method is IMDCT (Inverse Modified Discrete Cosine Transform (IMDCT). Also, the second domain inverse transformation unit 1120 outputs the result of inversely transforming via an output terminal OUT. For example, the second domain inverse transformation unit 1120 inversely transforms a signal that the combined result received from the noise decoding unit 1210 at an output terminal OUT1 of FIG. 12, and a signal that is the combined result received from the speech tool decoding unit 1320 at an output terminal OUT2 of FIG. 13, from the frequency domain to the time domain by performing IMDCT thereon.

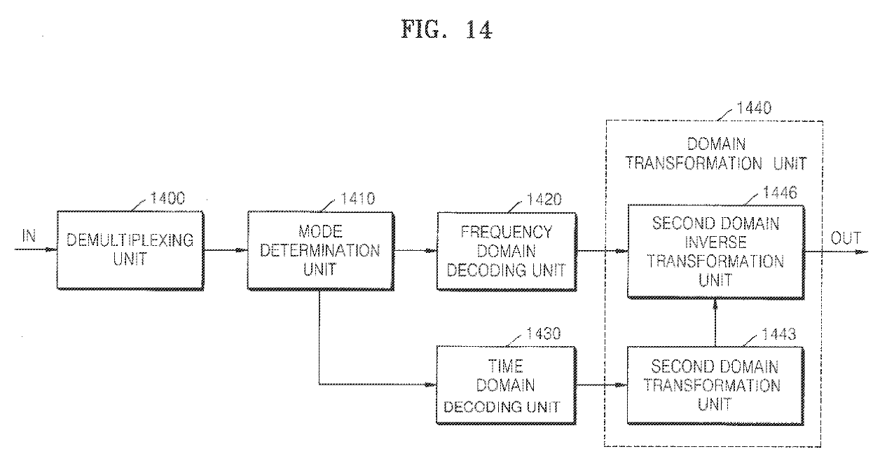

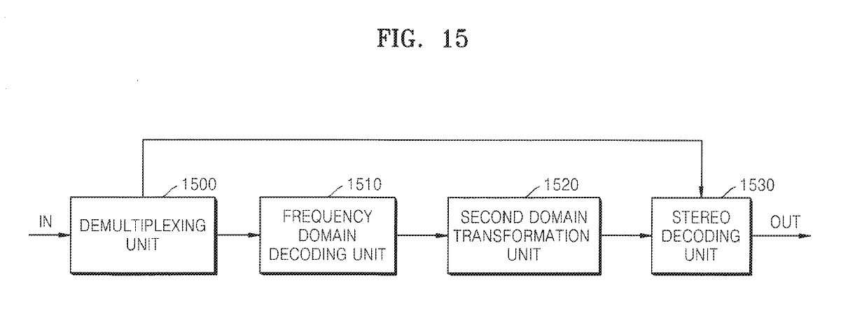

FIG. 14 is a block diagram illustrating an audio and/or speech signal decoding apparatus according to another embodiment of the present general inventive concept. The audio and/or speech signal decoding apparatus includes a demultiplexing unit 1400, a mode determination unit 1410, a frequency domain decoding unit 1420, a time domain decoding unit 1430 and a domain transformation unit 1440.

The demultiplexing unit 1400 receives a bitstream from an encoding terminal (not shown) via an input terminal IN and then demultiplexes the bitstream. The result of demultiplexing the bitstream output from the demultiplexing unit 1400 includes information regarding a domain in which each sub band has been encoded, the result of encoding for a predetermined sub band in the frequency domain by the encoding terminal, and the result of encoding for a predetermined sub band in the time domain by the encoding terminal.

Here, the result of encoding in the frequency domain may include the result of quantizing an important spectral component and the result of quantizing the noise levels of the remnant spectral components. In addition, the result of encoding in the frequency domain may include the result of encoding using a speech tool.

The mode determination unit 1410 reads the information regarding the domain in which each sub band has been encoded, which is received from the demultiplexing unit 1400, and then determines whether each sub band has been encoded in the frequency domain or the time domain.

The frequency domain decoding unit 1420 decodes one or more sub bands that are determined to have been encoded in the frequency domain by the mode determination unit 1410, in the frequency domain. More specifically, the frequency domain decoding unit 1420 decodes an important spectral component selected from each sub band, and the noise levels of the remnant spectral components. The frequency domain decoding unit 1420 may be constructed as illustrated in FIG. 12 or 13.

The time domain decoding unit 1430 decodes one or more sub bands that are determined to have been encoded in the time domain by the mode determination unit 1410, in the time domain.

It is possible that, even if the encoding terminal determines a specific sub band to be encoded in the time domain, the specific sub band may have been encoded in both the frequency domain and the time domain. The frequency domain decoding unit 1420 decodes the result of encoding the specific sub band in the frequency domain and the time domain decoding unit 1430 decodes the result of encoding the specific sub band in the time domain.

The domain transformation unit 1440 transforms the result of decoding by the time domain decoding unit 1430 from the time domain to the frequency domain, and combines the result of decoding by the frequency domain decoding unit 1420 with the result of transforming signals received from the time domain decoding unit 1430 into the frequency domain and then transforms the combined result from the frequency domain to the time domain.

Here, the domain transformation unit 1440 may be embodied to perform various transformation methods of receiving a plurality of signals that are divided in predetermined bands units and representing in the time domain or the frequency domain and then transforming the signals into the time domain. An example of such a transformation method is FV-MLT.

The domain transformation unit 1440 includes a second domain transformation unit 1443 and a second domain inverse transformation unit 1446.

The second domain transformation unit 1443 transforms the signal decoded by the time domain decoding unit 1430 from the time domain to the frequency domain according to the second transformation method. For example, the second transformation method may be MDCT.

The second domain inverse transformation unit 1446 combines a signal of the sub band(s) decoded by the frequency domain decoding unit 1420 with a signal of the sub bands transformed by the second domain transformation unit 1443, and then inversely transforms the combined result from the frequency domain to the time domain according to the second inversion transformation method. The second inversion transformation method is an inversion operation of the above second transformation method, and may be IMDCT. The second domain inverse transformation unit 1446 outputs the result of inversely transforming via an output terminal OUT.

FIG. 15 is a block diagram illustrating an audio and/or speech signal decoding apparatus according to another embodiment of the present general inventive concept. The audio and/or speech signal decoding apparatus includes a demultiplexing unit 1500, a frequency domain decoding unit 1510, a second domain inverse transformation unit 1520 and a stereo decoding unit 1530.

The demultiplexing unit 1500 receives a bitstream from an encoding terminal (not shown) via an input terminal IN and demultiplexes the bitstream. The result of demultiplexing the bitstream output from the demultiplexing unit 1500 includes the result of encoding in the frequency domain by the encoding terminal, and parameters for upmixing a mono signal to a stereo signal. The result of encoding in the frequency domain contains the result of quantizing an important spectral component and the result of quantizing the noise levels of the remnant spectral components. In addition, the result of demultiplexing the bitstream may further include the result of encoding using a speech tool.

The frequency domain decoding unit 1510 decodes the result of encoding by the encoding terminal in the frequency domain, which is received from the inverse multiplexing unit 1500. More specifically, the frequency domain decoding unit 1510 decodes an important spectral component selected from each of sub bands, and the noise levels of the remnant spectral components. The frequency domain decoding unit 1510 may be constructed as illustrated in FIG. 12 or 13.

The second domain inverse transformation unit 1520 inversely transforms the result of decoding by the frequency domain decoding unit 1510 from the frequency domain to the time domain according to a second inversion transformation method. The second inversion transformation method is an inverse operation of the above second transformation method. An example of the second inversion transformation method is IMDCT.

The stereo decoding unit 1530 upmixes a mono signal being inversely transformed by the second domain inverse transformation unit 1520 to a stereo signal by using the parameters for upmixing. Examples of the parameters include the difference between the energy levels of two channels, or the correlation or coherence between the two channels. The stereo decoding unit 1530 outputs the upmixed stereo signal via an output terminal OUT.

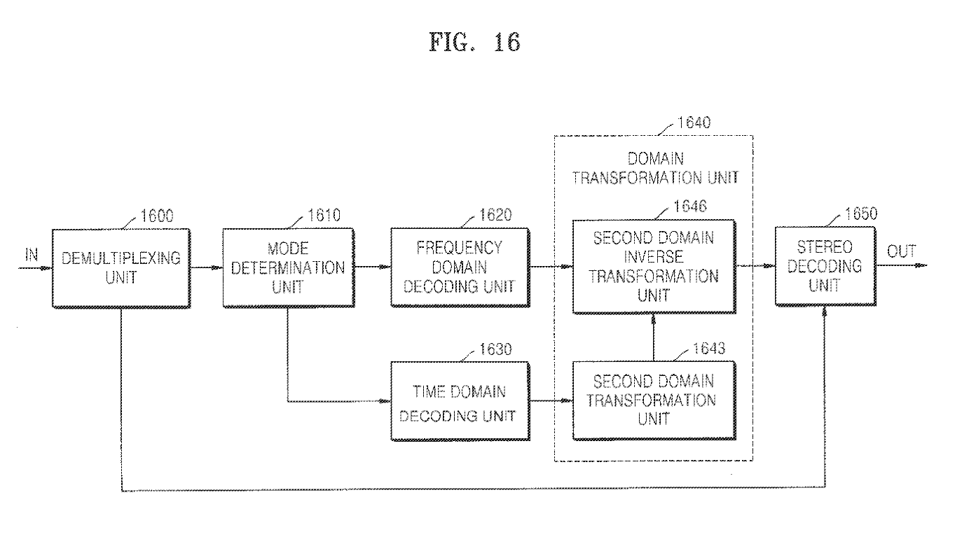

FIG. 16 is a block diagram illustrating an audio and/or speech signal decoding apparatus according to another embodiment of the present general inventive concept. The audio and/or speech signal decoding apparatus includes a demultiplexing unit 1600, a mode determination unit 1610, a frequency domain decoding unit 1620, a time domain decoding unit 1630, a domain transformation unit 1640 and a stereo decoding unit 1650.

The demultiplexing unit 1600 receives a bitstream from an encoding terminal (not shown) via an input terminal IN and demultiplexes the bitstream. Here, the result of demultiplexing output from the inverse multiplexing unit 1600 includes information regarding a domain in which each sub band has been encoded, the result of encoding a predetermined sub band in the frequency domain by the encoding terminal, the result of encoding a predetermined sub band in the time domain by the encoding terminal, and parameters for upmixing a mono signal to a stereo signal.

Here, the result of encoding in the frequency domain may include the result of quantizing an important spectral component and the result of quantizing the noise levels of the remnant spectral components. In addition, the result of encoding in the frequency domain may include the result of encoding using a speech tool.

The mode determination unit 1610 reads the information regarding the domain in which each sub band has been encoded, which is received from the demultiplexing unit 1600, and then determines whether each sub band has been encoded in the frequency domain or the time domain

The frequency domain decoding unit 1620 decodes one or more sub bands that are determined to have been encoded in the frequency domain by the mode determination unit 1610, in the frequency domain. More specifically, the frequency domain decoding unit 1620 decodes an important spectral component selected from each sub band, and the noise levels of the remnant spectral components. The frequency domain decoding unit 1620 may be constructed as illustrated in FIG. 12 or 13.

The time domain decoding unit 1630 decodes one or more sub bands that are determined to have been encoded in the time domain by the mode determination unit 1610, in the time domain.

It is possible that, even if the encoding terminal determines a specific sub band to be encoded in the time domain, the specific sub band may have been encoded in both the frequency domain and the time domain. The frequency domain decoding unit 1620 decodes the result of encoding the specific sub band in the frequency domain and the time domain decoding unit 1630 decodes the result of encoding the specific sub band in the time domain.

The domain transformation unit 1640 transforms the result of decoding by the time domain decoding unit 1630 from the time domain to the frequency domain, and combines the result of decoding by the frequency domain decoding unit 1620 with the result of transforming a signal received from the time domain decoding unit 1630 into the frequency domain and then transforms the combined result from the frequency domain to the time domain.

Here, the domain transformation unit 1640 may be embodied to perform various transformation methods of receiving a plurality of signals that are divided in predetermined bands units and representing in the time domain or the frequency domain and then transforming the signals into the time domain. An example of such a transformation method is FV-MLT.

The domain transformation unit 1640 includes a second domain transformation unit 1643 and a second domain inverse transformation unit 1646.

The second domain transformation unit 1643 transforms the signal decoded by the time domain decoding unit 1630 from the time domain to the frequency domain according to the second transformation method. For example, the second transformation method may be MDCT.

The second domain inverse transformation unit 1646 combines a signal of the sub band(s) decoded by the frequency domain decoding unit 1620 with a signal of the sub bands transformed by the second domain transformation unit 1643, and then inversely transforms the combined result from the frequency domain to the time domain according to the second inversion transformation method. The second inversion transformation method is an inversion operation of the above second transformation method, and may be IMDCT.

The stereo decoding unit 1650 upmixes a mono signal being inversely transformed by the second domain inverse transformation unit 1646 to a stereo signal by using the parameters for upmixing a mono signal to a stereo signal. Examples of the parameters include the difference between the energy levels of two channels, and the correlation or coherence between the two channels. Also, the stereo decoding unit 1650 outputs the upmixed stereo signal via an output terminal OUT.

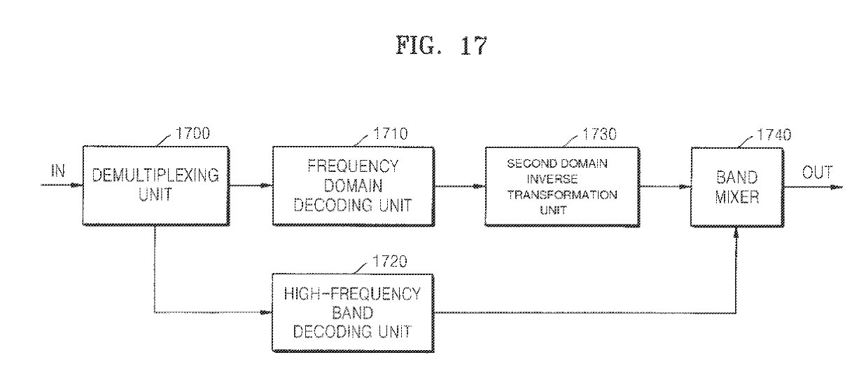

FIG. 17 is a block diagram illustrating an audio and/or speech signal decoding apparatus according to another embodiment of the present general inventive concept. The audio and/or speech signal decoding apparatus includes a demultiplexing unit 1700, a frequency domain decoding unit 1710, a high-frequency band decoding unit 1720, a second domain inverse transformation unit 1730 and a band mixer 1740.

The demultiplexing unit 1700 receives a bitstream from an encoding terminal (not shown) via an input terminal IN and demultiplexes the bitstream. Here, the result of demultiplexing the bitstream output from the demultiplexing unit 1700 includes the result of encoding in the frequency domain by the encoding terminal, and information for decoding a high-frequency band signal using a low-frequency band signal. The result of encoding in the frequency domain contains the result of quantizing an important spectral component and the result of quantizing the noise levels of the remnant spectral components. In addition, the result of demultiplexing the bitstream may further include the result of encoding using a speech tool.

The frequency domain decoding unit 1710 decodes the result of encoding by the encoding terminal in the frequency domain, which is received from the inverse multiplexing unit 1700. More specifically, the frequency domain decoding unit 1710 decodes an important spectral component selected from each of sub bands, and the noise levels of the remnant spectral components. The frequency domain decoding unit 1710 may be constructed as illustrated in FIG. 12 or 13.

The second domain inverse transformation unit 1730 inversely transforms the result of decoding by the frequency domain decoding unit 1710 from the frequency domain to the time domain according to a second inversion transformation method. The second inversion transformation method is an inverse operation of the above second transformation method. An example of the second inversion transformation method is IMDCT.

The high-frequency band decoding unit 1720 receives the information for decoding a high-frequency band signal using a low-frequency band signal from the demultiplexing unit 1700 and then generates a high-frequency band signal using a low-frequency band signal.

The band mixer 1740 mixes the low-frequency band signal being inversely transformed by the second domain inverse transformation unit 1730 and the high-frequency band signal generating by the high-frequency band decoding unit 1720 together. Then the band mixer 1740 outputs the result of mixing via an output terminal OUT.

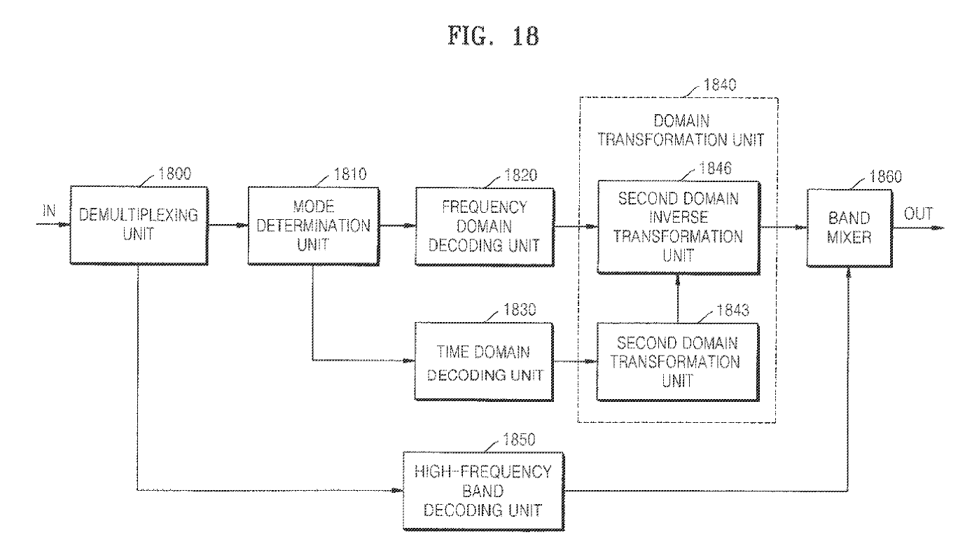

FIG. 18 is a block diagram illustrating an audio and/or speech signal decoding apparatus according to another embodiment of the present general inventive concept. The audio and/or speech signal decoding apparatus includes a demultiplexing unit 1800, a mode determination unit 1810, a frequency domain decoding unit 1820, a time domain decoding unit 1830, a domain transformation unit 1840, a high-frequency band decoding unit 1850 and a band mixer 1860.

The demultiplexing unit 1800 receives a bitstream from an encoding terminal (not shown) via an input terminal IN and then demultiplexes the bitstream. The result of demultiplexing the bitstream output from the demultiplexing unit 1800 includes information regarding a domain in which each sub band has been encoded, the result of encoding for a predetermined sub band in the frequency domain by the encoding terminal, the result of encoding for a predetermined sub band in the time domain by the encoding terminal, and information for decoding a high-frequency band signal using a low-frequency band signal.

Here, the result of encoding in the frequency domain may include the result of quantizing an important spectral component and the result of quantizing the noise levels of the remnant spectral components. In addition, the result of encoding in the frequency domain may include the result of encoding using a speech tool.

The mode determination unit 1810 reads the information regarding the domain in which each sub band has been encoded, which is received from the demultiplexing unit 1800, and then determines whether each sub band has been encoded in the frequency domain or the time domain.

The frequency domain decoding unit 1820 decodes one or more sub bands that are determined to have been encoded in the frequency domain by the mode determination unit 1810, in the frequency domain. More specifically, the frequency domain decoding unit 1820 decodes an important spectral component selected from each sub band, and the noise levels of the remnant spectral components. The frequency domain decoding unit 1820 may be constructed as illustrated in FIG. 12 or 13.

The time domain decoding unit 1830 decodes one or more sub bands that are determined to have been encoded in the time domain by the mode determination unit 1810, in the time domain.

It is possible that, even if the encoding terminal determines a specific sub band to be encoded in the time domain, the specific sub band may have been encoded in both the frequency domain and the time domain. The frequency domain decoding unit 1820 decodes the result of encoding the specific sub band in the frequency domain and the time domain decoding unit 1830 decodes the result of encoding the specific sub band in the time domain.

The domain inverse transformation unit 1840 transforms the result of decoding by the time domain decoding unit 1830 from the time domain to the frequency domain, and combines the result of decoding by the frequency domain decoding unit 1820 with the result of transforming signals received from the time domain decoding unit 1830 into the frequency domain and then transforms the combined result from the frequency domain to the time domain.

Here, the domain transformation unit 1840 may be embodied to perform various transformation methods of receiving a plurality of signals that are divided in predetermined bands units and representing in the time domain or the frequency domain and then transforming the signals into the time domain. An example of such a transformation method is FV-MLT.

The domain transformation unit 1840 includes a second domain transformation unit 1843 and a second domain inverse transformation unit 1846.

The second domain transformation unit 1843 transforms the signal decoded by the time domain decoding unit 1830 from the time domain to the frequency domain according to the second transformation method. For example, the second transformation method may be MDCT.

The second domain inverse transformation unit 1846 combines a signal of the sub band(s) decoded by the frequency domain decoding unit 1820 with a signal of the sub bands transformed by the second domain transformation unit 1843, and then inversely transforms the combined result from the frequency domain to the time domain according to the second inversion transformation method. The second inversion transformation method is an inversion operation of the above second transformation method, and may be IMDCT.

The high-frequency band decoding unit 1850 receives the information for decoding a high-frequency band signal using a low-frequency band signal from the demultiplexing unit 1800 and then generates a high-frequency band signal using a low-frequency band signal.

The band mixer 1860 combines the low-frequency band signal being inversely transformed by the second domain inverse transformation unit 1846 and the high-frequency band signal generating by the high-frequency band decoding unit 1850 together. Then the band mixer 1860 outputs the result of combining via an output terminal OUT.

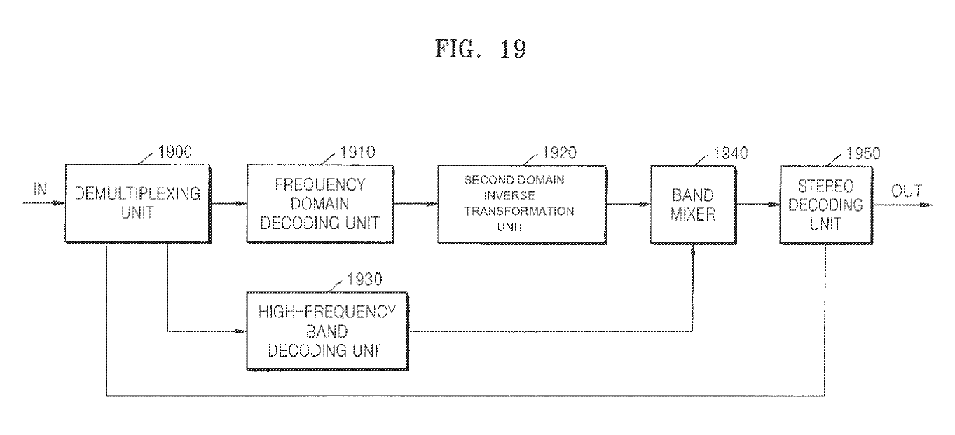

FIG. 19 is a block diagram illustrating an audio and/or speech signal decoding apparatus according to another embodiment of the present general inventive concept. The audio and/or speech signal decoding apparatus includes a demultiplexing unit 1900, a frequency domain decoding unit 1910, a second domain inverse transformation unit 1920, a high-frequency band decoding unit 1930, a band mixer 1940 and a stereo decoding unit 1950.

The demultiplexing unit 1900 receives a bitstream from an encoding terminal (not shown) via an input terminal IN and demultiplexes the bitstream. Here, the result of demultiplexing the bitstream output from the demultiplexing unit 1900 includes the result of encoding in the frequency domain by the encoding terminal, information for decoding a high-frequency band signal using a low-frequency band signal, and parameters for upmixing a mono signal to a stereo signal. The result of encoding in the frequency domain contains the result of quantizing an important spectral component and the result of quantizing the noise levels of the remnant spectral components. In addition, the result of demultiplexing the bitstream may further include the result of encoding using a speech tool.

The frequency domain decoding unit 1910 decodes the result of encoding by the encoding terminal in the frequency domain, which is received from the inverse multiplexing unit 1900. More specifically, the frequency domain decoding unit 1910 decodes an important spectral component selected from each of sub bands, and the noise levels of the remnant spectral components. The frequency domain decoding unit 1910 may be constructed as illustrated in FIG. 12 or 13.

The second domain inverse transformation unit 1920 inversely transforms the result of decoding by the frequency domain decoding unit 1910 from the frequency domain to the time domain according to a second inversion transformation method. The second inversion transformation method is an inverse operation of the above second transformation method. An example of the second inversion transformation method is IMDCT.

The high-frequency band decoding unit 1930 receives the information for decoding a high-frequency band signal using a low-frequency band signal from the demultiplexing unit 1900 and then generates a high-frequency band signal using a low-frequency band signal.

The band mixer 1940 mixes the low-frequency band signal being inversely transformed by the second domain inverse transformation unit 1920 and the high-frequency band signal generated by the high-frequency band decoding unit 1930 together.

The stereo decoding unit 1950 upmixes a mono signal received from the band mixer 1940 to a stereo signal by using the parameters for upmixing a mono signal to a stereo signal, which is received from the demultiplexing unit 1900. Examples of the parameters include the difference between the energy levels of two channels, or the correlation or coherence between the two channels. The stereo decoding unit 1950 outputs the upmixed stereo signal via an output terminal OUT.

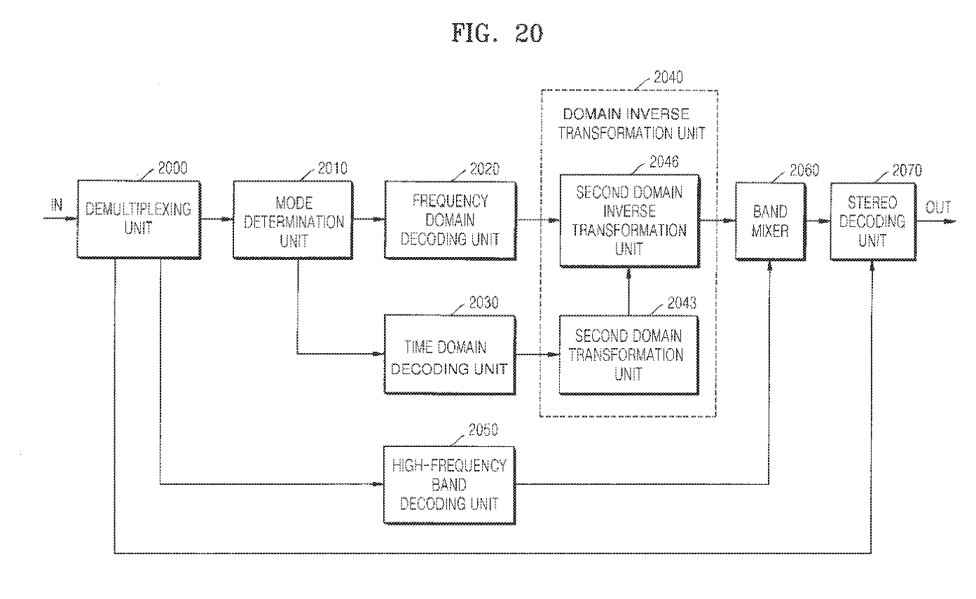

FIG. 20 is a block diagram illustrating an audio and/or speech signal decoding apparatus according to another embodiment of the present general inventive concept. The audio and/or speech signal decoding apparatus includes a demultiplexing unit 2000, a mode determination unit 2010, a frequency domain decoding unit 2020, a time domain decoding unit 2030, a domain inverse transformation unit 2040, a high-frequency band decoding unit 2050, a band mixer 2060 and a stereo decoding unit 2070.

The demultiplexing unit 2000 receives a bitstream from an encoding terminal (not shown) via an input terminal IN and demultiplexes the bitstream. Here, the result of demultiplexing output from the inverse multiplexing unit 2000 includes information regarding a domain in which each sub band has been encoded, the result of encoding a predetermined sub band in the frequency domain by the encoding terminal, the result of encoding a predetermined sub band in the time domain by the encoding terminal, and information for decoding a high-frequency band signal using a low-frequency band signal.

Here, the result of encoding in the frequency domain may include the result of quantizing an important spectral component and the result of quantizing the noise levels of the remnant spectral components. In addition, the result of encoding in the frequency domain may include the result of encoding using a speech tool.

The mode determination unit 2010 reads the information regarding the domain in which each sub band has been encoded, which is received from the demultiplexing unit 2000, and then determines whether each sub band has been encoded in the frequency domain or the time domain.

The frequency domain decoding unit 2020 decodes one or more sub bands that are determined to have been encoded in the frequency domain by the mode determination unit 2010, in the frequency domain. More specifically, the frequency domain decoding unit 2020 decodes an important spectral component selected from each sub band, and the noise levels of the remnant spectral components. The frequency domain decoding unit 2020 may be constructed as illustrated in FIG. 12 or 13.

The time domain decoding unit 2030 decodes one or more sub bands that are determined to have been encoded in the time domain by the mode determination unit 2010, in the time domain.

It is possible that, even if the encoding terminal determines a specific sub band to be encoded in the time domain, the specific sub band may have been encoded in both the frequency domain and the time domain. The frequency domain decoding unit 2020 decodes the result of encoding the specific sub band in the frequency domain and the time domain decoding unit 2030 decodes the result of encoding the specific sub band in the time domain.

The domain inverse transformation unit 2040 transforms the result of decoding by the time domain decoding unit 2030 from the time domain to the frequency domain, and combines the result of decoding by the frequency domain decoding unit 2020 with the result of transforming signals received from the time domain decoding unit 2030 into the frequency domain and then transforms the combined result from the frequency domain to the time domain.

Here, the domain inverse transformation unit 2040 may be embodied to perform various transformation methods of receiving a plurality of signals that are divided in predetermined bands units and representing in the time domain or the frequency domain and then transforming the signals into the time domain. An example of such a transformation method is FV-MLT.

The domain inverse transformation unit 2040 includes a second domain transformation unit 2043 and a second domain inverse transformation unit 2046.

The second domain transformation unit 2043 transforms the signal decoded by the time domain decoding unit 2030 from the time domain to the frequency domain according to the second transformation method. For example, the second transformation method may be MDCT.

The second domain inverse transformation unit 2046 combines a signal of the sub band(s) decoded by the frequency domain decoding unit 2020 with a signal of the sub bands transformed by the second domain transformation unit 2043, and then inversely transforms the combined result from the frequency domain to the time domain according to the second inversion transformation method. The second inversion transformation method is an inversion operation of the above second transformation method, and may be IMDCT.

The high-frequency band decoding unit 2050 receives the information for decoding a high-frequency band signal using a low-frequency band signal from the demultiplexing unit 2000 and then generates a high-frequency band signal using a low-frequency band signal.

The band mixer 2060 mixes the low-frequency band signal being inversely transformed by the second domain inverse transformation unit 2046 and the high-frequency band signal generated by the high-frequency band decoding unit 2050 together.

The stereo decoding unit 2070 upmixes a mono signal received from the band mixer 2060 to a stereo signal by using the parameters for upmixing a mono signal to a stereo signal, which is received from the demultiplexing unit 2000. Examples of the parameters include the difference between the energy levels of two channels, or the correlation or coherence between the two channels. The stereo decoding unit 2070 outputs the upmixed stereo signal via an output terminal OUT.

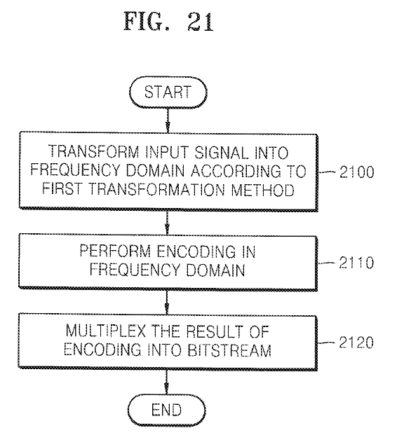

FIG. 21 is a flowchart illustrating an audio and/or speech signal encoding method according to an embodiment of the present general inventive concept. First, an input signal is transformed from the time domain to the frequency domain and then divided into units of sub bands (operation 2100). In operation 2100, the input signal is transformed from the time domain to the frequency domain according to a first transformation method, and is transformed again from the time domain to the frequency domain according to a second transformation method that is different from the first transformation method in order to apply the psychoacoustic model to the input signal. The signal transformed according to the first transformation method is used in order to encode the input signal, and the signal transformed according to the second transformation method is used in order to apply the psychoacoustic model to the input signal.

For example, in operation 2100, the input signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, DFT is performed on the signal corresponding to the time domain and then MDCT coefficients are quantized, thereby preventing a mismatch from occurring.

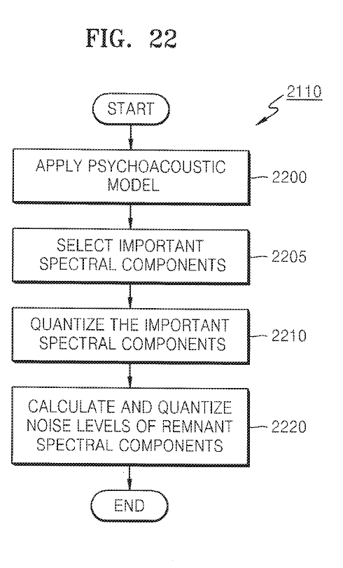

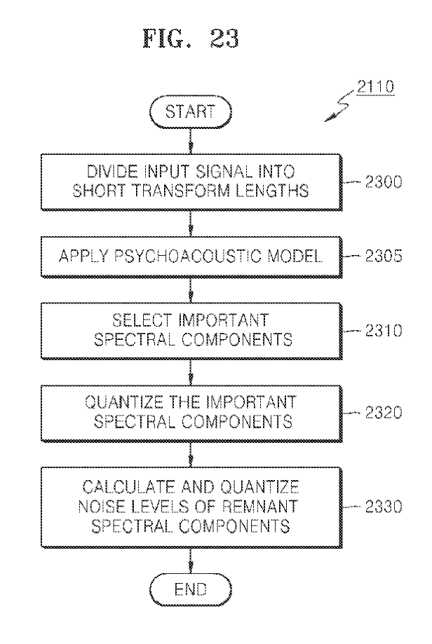

Next, an important spectral component is selected from each of sub bands of the signal transformed according to the first transformation method in operation 2100, the selected component is quantized, the remnant spectral components except the important spectral components are extracted, and then the noise levels of the remnant spectral components are calculated and quantized (operation 2110). Operation 2110 may be performed as illustrated in FIG. 22 or 23.

FIG. 22 is a flowchart illustrating the operation 2110 of the audio and/or speech signal encoding method illustrated in FIG. 21 according to an embodiment of the present general inventive concept.

First, the psychoacoustic model is applied to the input signal in order to remove perceptual redundancy caused by the human auditory characteristics (operation 2200). Here, the psychoacoustic model means a mathematic model regarding the masking reaction of the human auditory system.

In operation 2200, low-sensitivity particular information is omitted by applying the psychoacoustic model using the human auditory system, and a signal-to-masking ratio (SMR) indicating the intensity of sensation is allocated in units of frequencies. In operation 2200, the psychoacoustic model is applied using the signal transformed according to the second transformation method. An example of the second transformation method is MDST.

After operation 2200, an important spectral component is selected from each of sub bands of the signal being represented in the frequency domain (operation 2205). In this case, various methods may be used in order to select an important spectral component. First, the SMR of a signal is calculated and then the signal is determined as an important spectral component if the SMR is greater than a reciprocal number of a masking value. Second, an important spectral component is selected by extracting a spectrum peak in consideration of a predetermined weight. Third, a signal-to-noise ratio (SNR) of each of sub bands is calculated, and then a spectral component whose peak value is equal to or greater than a predetermined value is selected from among sub bands having a small SNR. The above three methods may be individually performed or one or a combination of at least two of the three methods may be performed.

Next, the important spectral components selected in operation 2205 are quantized using the SMRs allocated in operation 2200 (operation 2210).

After operation 2210, the remnant spectral components except the important spectral components selected in operation 2205 are extracted from the signal being represented in the frequency domain, and then the noise levels of the remnant spectral components are calculated and quantized (operation 2220).

FIG. 23 is a flowchart illustrating the operation 2110 of the audio and/or speech signal encoding method illustrated in FIG. 21 according to another embodiment of the present general inventive concept.

First, a signal being determined as a strong attack signal is finely encoded by dividing it into short transform lengths (operation 2300).

After operation 2300, the psychoacoustic model is applied to the input signal in order to remove perceptual redundancy caused by the human auditory characteristics (operation 2305).

In operation 2305, low-sensitivity particular information is omitted by applying the psychoacoustic model using the human auditory system, and an SMR indicating the intensity of sensation is allocated in units of frequencies while changing the SMR. In operation 2305, the psychoacoustic model is applied using the signal transformed according to the second transformation method. An example of the second transformation method is MDST.

After operation 2305, an important spectral component is selected from each of sub bands of the signal being represented in the frequency domain (operation 2310). In this case, various methods may be used in order to select an important spectral component. First, the SMR of a signal is calculated and then the signal is determined as an important spectral component if the SMR is greater than a reciprocal number of a masking value. Second, an important spectral component is selected by extracting a spectrum peak in consideration of a predetermined weight. Third, a signal-to-noise ratio (SNR) of each of sub bands is calculated, and then a spectral component whose peak value is equal to or greater than a predetermined value is selected from among sub bands having a small SNR. The above three methods may be individually performed or one or a combination of at least two of the three methods may be performed.

Then the important spectral components selected in operation 2310 are quantized using the SMRs allocated in operation 2305 (operation 2320).

After operation 2320, the remnant spectral components except the important spectral components selected in operation 2310 are extracted from the signal being represented in the frequency domain, and then the noise levels of the remnant spectral components are calculated and quantized in units of sub bands (operation 2330).

Here, the noise level may be calculated by performing the linear prediction analysis. The linear prediction analysis is performed using the autocorrelation method, but may be performed using the covariance method or the Durbin's method. Linear prediction allows an encoding unit to predict the amount of noise components present in a current frame. If more noise components are present, the remnant spectral components are directly transmitted without changing their noise levels. If less noise components are present and more tone components are present, the remnant spectral components are transmitted by reducing their noise levels. Also, in the case of a small window indicating that noise rapidly changes, the remnant spectral components are transmitted by additionally reducing their noise levels.

Next, referring to FIG. 21, the result of encoding in operation 2110 is multiplexed into a bitstream (operation 2120). The result of encoding in operation 2110 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

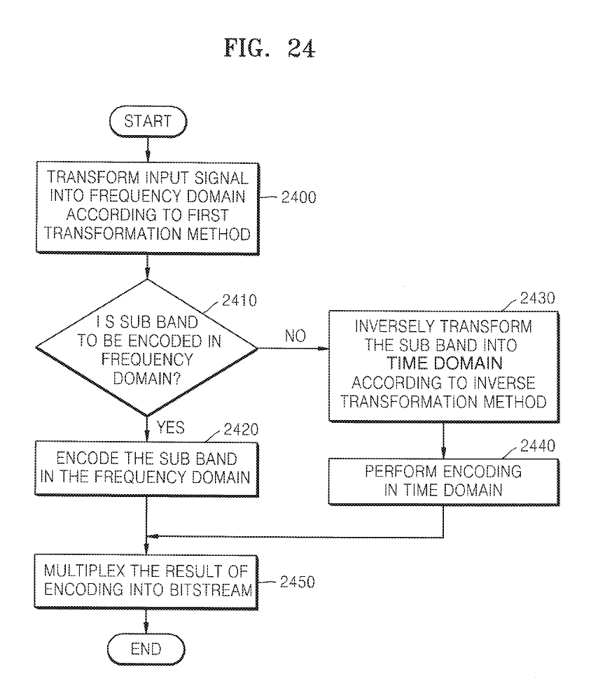

FIG. 24 is a flowchart illustrating an audio and/or speech signal encoding method according to another embodiment of the present general inventive concept. First, an input signal is transformed from the time domain to the frequency domain and then divided into units of sub bands (operation 2400). In operation 2400, the input signal is transformed from the time domain to the frequency domain according to a first transformation method, and is transformed again from the time domain to the frequency domain according to a second transformation method that is different from the first transformation method in order to apply the psychoacoustic model to the input signal. The signal transformed according to the first transformation method is used in order to encode the input signal, and the signal transformed according to the second transformation method is used in order to apply the psychoacoustic model to the input signal.

For example, in operation 2400, the input signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, DFT is performed on the signal corresponding to the time domain and then MDCT coefficients are quantized, thereby preventing a mismatch from occurring. The psychoacoustic model means a mathematic model regarding the masking reaction of the human auditory system.

Next, it is determined whether it is appropriate to encode each of the sub bands of the signal, which was transformed into the frequency domain in operation 2400, in the frequency domain (operation 2410). In other words, in operation 2410, whether each of the sub bands of the signal transformed into the frequency domain is to be encoded in the frequency domain or in the time domain is determined based on a predetermined basis. Also, in operation 2410, an identifier indicating a domain for each of the sub bands that is determined here is quantized.

In operation 2410, either one of or both the signal transformed into the frequency domain in operation 2400 and the input signal corresponding to the time domain may be used in order to determine whether a predetermined sub band is to be encoded in the frequency domain.

If it is determined in operation 2410 that each of the sub bands is to be encoded in the frequency domain, it is encoded in the frequency domain (operation 2420). Operation 2420 may be performed as illustrated in FIG. 22 or 23.

If it is determined in operation 2410 that each of the sub bands is not to be encoded in the frequency domain, it is inversely transformed from the frequency domain to the time domain according to an inverse transformation method of the first transformation method (operation 2430). For example, the inverse transformation method of the first transformation method may be IMDCT.

Operations 2400 and 2430 may be embodied as various transformation methods of receiving a signal represented in the time domain and representing it both in the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, a signal to which the psychoacoustic model is to be applied using imaginary numbers is generated. An example of such a transformation method is FV-MLT.

Next, the signal being inversely transformed into the time domain in units of sub bands in operation 2430 is encoded in the time domain (operation 2440).

It is possible that, even if it is determined in operation 2410 that a specific sub band is not to be encoded in the frequency domain, a signal of the specific sub band can be encoded in both the frequency domain and the time domain. Thus one or more predetermined sub bands are encoded not only in the time domain but also in the frequency domain. In this case, an identifier indicating that the signal of the predetermined sub band(s) has been encoded both in the time domain and the frequency domain is quantized.

After operation 2420 or 2440, the result of quantizing the identifier indicating a domain in which that each of the sub bands has been encoded, the result of encoding in operation 2440, and the result of encoding in operation 2420 are multiplexed into a bitstream (operation 2450). The result of encoding operation 2420 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

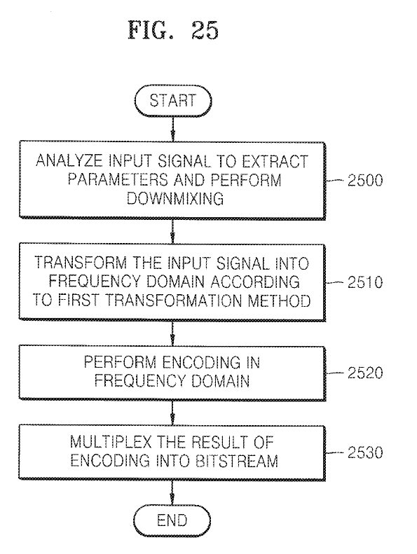

FIG. 25 is a flowchart illustrating an audio and/or speech signal encoding method according to another embodiment of the present general inventive concept. First, if an input signal is a stereo signal, the input signal is analyzed to extract parameters and then is downmixed (operation 2500). The parameters extracted in operation 2500 indicate information needed for a decoding unit to upmix a mono signal received from an encoding unit to a stereo signal. Examples of the parameters include the difference between the energy levels of two channels, or the correlation or coherence between the two channels. Also, the parameters extracted are quantized in operation 2500.

The signal being downmixed in operation 2500 is transformed from the time domain to the frequency domain and then divided into units of sub bands (operation 2510). In operation 2510, the signal being downmixed in operation 2500 is transformed from the time domain to the frequency domain according to a first transformation method, and the input signal is transformed from the time domain to the frequency domain according to a second transformation method that is different from the first transformation method in order to apply the psychoacoustic model to the input signal. The signal transformed according to the first transformation method is used in order to encode the input signal, and the signal transformed according to the second transformation method is used in order to apply the psychoacoustic model to the input signal. The psychoacoustic model means a mathematic model regarding the masking reaction of the human auditory system.

For example, in operation 2510, the input signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, DFT is performed on the signal corresponding to the time domain and then MDCT coefficients are quantized, thereby preventing a mismatch from occurring.

Next, an important spectral component is selected from each of sub bands of the signal transformed according to the first transformation method in operation 2510, the selected component is quantized, the remnant spectral components except the important spectral components are extracted, and then the noise levels of the remnant spectral components are calculated and quantized (operation 2520). Operation 2520 may be performed as illustrated in FIG. 22 or 23.

Next, the parameters extracted in operation 2500 and the result of quantization in operation 2520 are multiplexed into a bitstream (operation 2530). The result of encoding in operation 2520 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

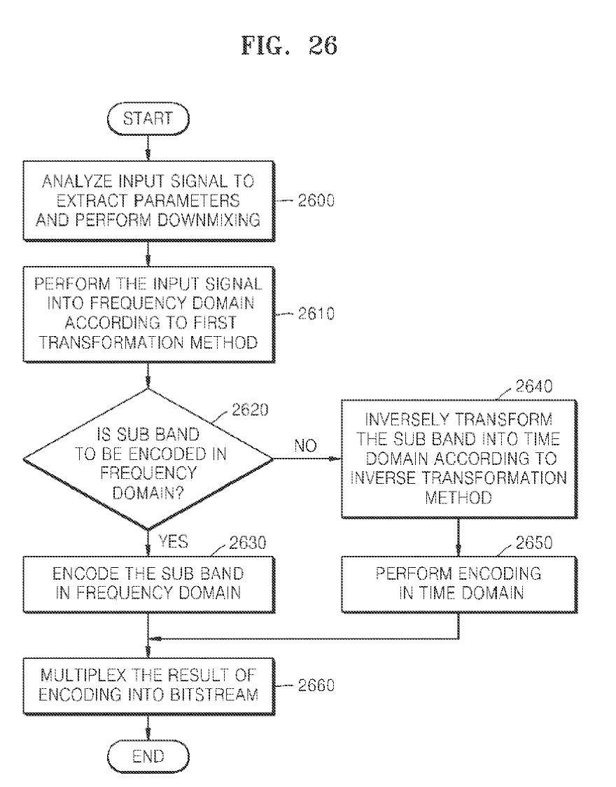

FIG. 26 is a flowchart illustrating an audio and/or speech signal encoding method according to another embodiment of the present general inventive concept. First, if an input signal is a stereo signal, the input signal is analyzed to extract parameters and then is downmixed (operation 2600). The parameters extracted in operation 2600 indicate information needed for a decoding unit to upmix a mono signal received from an encoding unit to a stereo signal. Examples of the parameters include the difference between the energy levels of two channels, or the correlation or coherence between the two channels. Also, the extracted parameters extracted are quantized in operation 2600.

The signal being downmixed in operation 2600 is transformed from the time domain to the frequency domain and then divided into units of sub bands (operation 2610). In operation 2610, the signal being downmixed in operation 2600 is transformed from the time domain to the frequency domain according to a first transformation method, and the signal being downmixed in operation 2600 is transformed from the time domain to the frequency domain according to a second transformation method that is different from the first transformation method in order to apply the psychoacoustic model to the input signal. The signal transformed according to the first transformation method is used in order to encode the input signal, and the signal transformed according to the second transformation method is used in order to apply the psychoacoustic model to the input signal.

For example, in operation 2610, the input signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the input signal, and the signal represented with imaginary numbers as a result of using MDST is used for applying the psychoacoustic model to the input signal. Thus, since phase information of the input signal can be further represented, DFT is performed on the signal corresponding to the time domain and then MDCT coefficients are quantized, thereby preventing a mismatch from occurring. The psychoacoustic model means a mathematic model regarding the masking reaction of the human auditory system.

Next, it is determined whether it is appropriate to encode each of the sub bands of the signal, which was transformed into the frequency domain in operation 2610, in the frequency domain (operation 2620). In other words, in operation 2620, whether each of the sub bands of the signal transformed into the frequency domain is to be encoded in the frequency domain or in the time domain is determined based on a predetermined basis. Also, in operation 2620, an identifier indicating a domain for each of the sub bands that is determined here is quantized.

In operation 2620, either one of or both the signal transformed into the frequency domain in operation 2610, and the signal corresponding to the time domain, which was downmixed in operation 2600, may be used in order to determine whether a predetermined sub band is to be encoded in the frequency domain.

If it is determined in operation 2620 that each of the sub bands is to be encoded in the frequency domain, it is encoded in the frequency domain (operation 2630). Operation 2630 may be performed as illustrated in FIG. 22 or 23.

If it is determined in operation 2620 that each of the sub bands is not to be encoded in the frequency domain, it is inversely transformed from the frequency domain to the time domain according to an inverse transformation method of the first transformation method (operation 2640). For example, the inverse transformation method of the first transformation method may be IMDCT.

Operations 2610 and 2640 may be embodied as various transformation methods of receiving a signal represented in the time domain and representing it both in the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, a signal to which the psychoacoustic model is to be applied using imaginary numbers is generated. An example of such a transformation method is FV-MLT.

Next, the signal being inversely transformed into the time domain in units of sub bands in operation 2640 is encoded in the time domain (operation 2650).

It is possible that, even if it is determined in operation 2620 that a specific sub band is not to be encoded in the frequency domain, a signal of the specific sub band can be encoded in both the frequency domain and the time domain. Thus one or more predetermined sub bands are encoded not only in the time domain but also in the frequency domain. In this case, an identifier indicating that the signal of the predetermined sub band(s) has been encoded both in the time domain and the frequency domain is quantized.

After operation 2630 or 2650, the result of quantizing the identifier indicating a domain in which that each of the sub bands has been encoded, the result of encoding in operation 2600, the result of encoding in operation 2630, and the result of encoding in operation 2650 are multiplexed into a bitstream (operation 2660). The result of encoding operation 2630 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

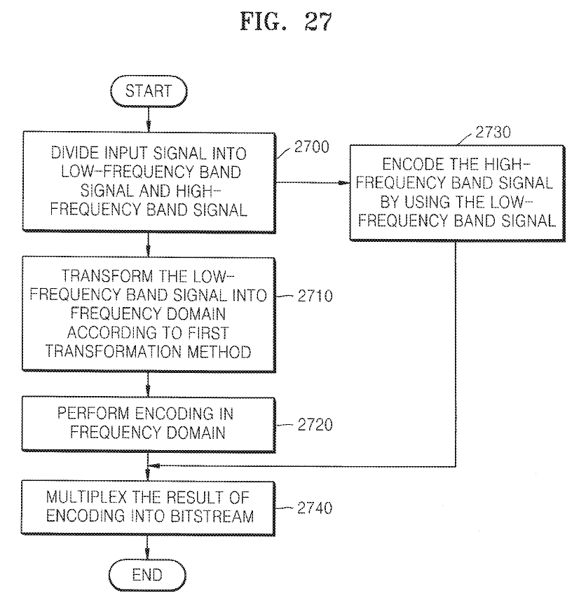

FIG. 27 is a flowchart illustrating an audio and/or speech signal encoding method according to another embodiment of the present general inventive concept. First, an input signal is divided into a low-frequency band signal and a high-frequency band signal, based on a predetermined frequency (operation 2700).

Then the low-frequency band signal obtained in operation 2700 is transformed from the time domain to the frequency domain and then divided in units of sub bands (operation 2710). In operation 2710, the low-frequency band signal is transformed from the time domain to the frequency domain according to a first transformation method, and is transformed again from the time domain to the frequency domain according to a second transformation method that is different from the first transformation method in order to apply the psychoacoustic model to the low-frequency band signal. The signal transformed according to the first transformation method is used in order to encode the low-frequency band signal, and the signal transformed according to the second transformation method is used in order to apply the psychoacoustic model to the low-frequency band signal. The psychoacoustic model means a mathematic model regarding the masking reaction of the human auditory system.

For example, in operation 2710, the low-frequency band signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring.

Next, an important spectral component is selected from each of sub bands of the signal transformed according to the first transformation method in operation 2710, the selected component is quantized, the remnant spectral components except the important spectral components are extracted, and then the noise levels of the remnant spectral components are calculated and quantized encoded (operation 2720). Operation 2720 may be performed as illustrated in FIG. 22 or 23.

The high-frequency band signal obtained in operation 2700 is encoded using the low-frequency band signal (operation 2730).

Then the result of encoding in operation 2720, and the result of encoding in operation 2730, and information for decoding the high-frequency band signal using the low-frequency band signal are multiplexed into a bitstream (operation 2740). The result of encoding operation 2720 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

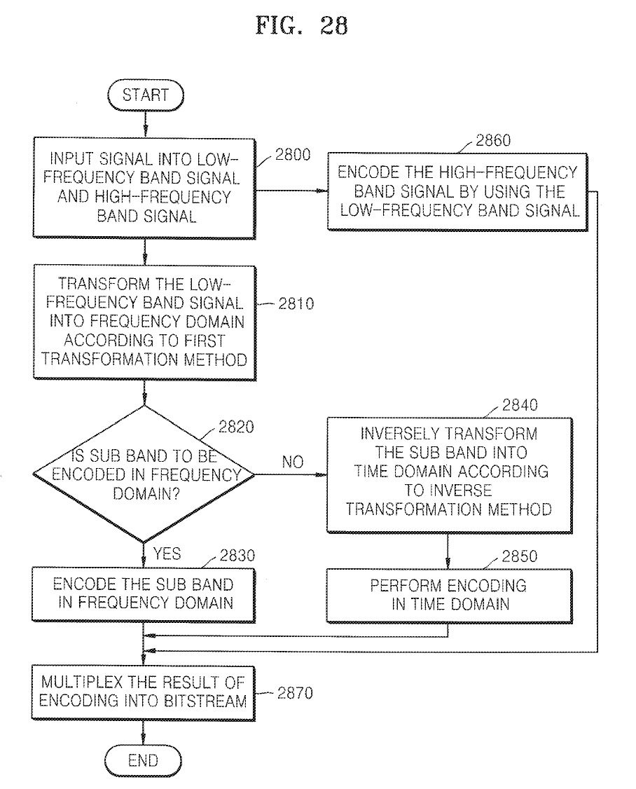

FIG. 28 is a flowchart illustrating an audio and/or speech signal encoding method according to another embodiment of the present general inventive concept. First, an input signal is divided into a low-frequency band signal and a high-frequency band signal, based on a predetermined frequency (operation 2800).

Then the low-frequency band signal obtained in operation 2800 is transformed from the time domain to the frequency domain and then divided in units of sub bands (operation 2810). In operation 2810, the low-frequency band signal is transformed from the time domain to the frequency domain according to a first transformation method, and is transformed again from the time domain to the frequency domain according to a second transformation method that is different from the first transformation method in order to apply the psychoacoustic model to the low-frequency band signal. The signal transformed according to the first transformation method is used in order to encode the low-frequency band signal, and the signal transformed according to the second transformation method is used in order to apply the psychoacoustic model to the low-frequency band signal.

For example, in operation 2810, the low-frequency band signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring. The psychoacoustic model means a mathematic model regarding the masking reaction of the human auditory system.

Next, it is determined whether it is appropriate to encode each of the sub bands of the signal, which was transformed into the frequency domain in operation 2810, in the frequency domain (operation 2820). In other words, in operation 2820, whether each of the sub bands of the signal transformed into the frequency domain is to be encoded in the frequency domain or in the time domain is determined based on a predetermined basis. Also, in operation 2820, an identifier indicating a domain for each of the sub bands that is determined here is quantized.

In operation 2820, either one of or both the signal transformed into the frequency domain in operation 2810, the low-frequency band signal corresponding to the time domain may be used in order to determine whether a predetermined sub band is to be encoded in the frequency domain.

If it is determined in operation 2820 that each of the sub bands is to be encoded in the frequency domain, it is encoded in the frequency domain (operation 2830). Operation 2830 may be performed as illustrated in FIG. 22 or 23.

If it is determined in operation 2820 that each of the sub bands is not to be encoded in the frequency domain, it is inversely transformed from the frequency domain to the time domain according to an inverse transformation method of the first transformation method (operation 2840). For example, the inverse transformation method of the first transformation method may be IMDCT.

Operations 2810 and 2840 may be embodied as various transformation methods of receiving a signal represented in the time domain and representing it both in the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, a signal to which the psychoacoustic model is to be applied using imaginary numbers is generated. An example of such a transformation method is FV-MLT.

Next, the signal being inversely transformed into the time domain in units of sub bands in operation 2840 is encoded in the time domain (operation 2850).

It is possible that, even if it is determined in operation 2820 that a specific sub band is not to be encoded in the frequency domain, a signal of the specific sub band can be encoded in both the frequency domain and the time domain. Thus one or more predetermined sub bands are encoded not only in the time domain but also in the frequency domain. In this case, an identifier indicating that the signal of the predetermined sub band(s) has been encoded both in the time domain and the frequency domain is quantized.

The high-frequency band signal obtained in operation 2800 is encoded using the low-frequency band signal (operation 2860).

After operation 2830 or 2850, the result of quantizing the identifier indicating a domain in which that each of the sub bands has been encoded, the result of encoding in operation 2830, the result of encoding in operation 2850, and information for decoding the high-frequency band signal using the low-frequency band signal are multiplexed into a bitstream (operation 2870). The result of encoding operation 2830 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

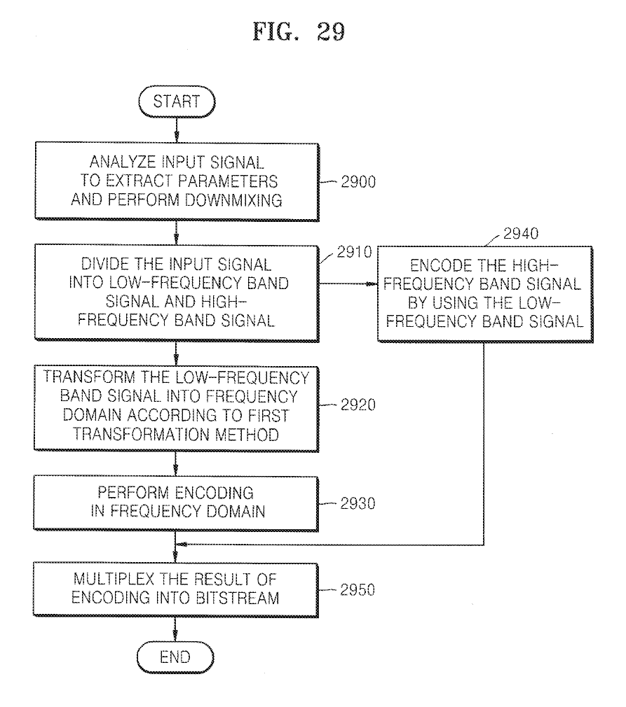

FIG. 29 is a flowchart illustrating an audio and/or speech signal encoding method according to another embodiment of the present general inventive concept. First, if an input signal is a stereo signal, the input signal is analyzed to extract parameters and then is downmixed (operation 2900). The parameters extracted in operation 2900 indicate information needed for a decoding unit to upmix a mono signal received from an encoding unit to a stereo signal. Examples of the parameters include the difference between the energy levels of two channels, or the correlation or coherence between the two channels. Also, the parameters extracted are quantized in operation 2900.

Next, the signal being downmixed in operation 2900 is divided into a low-frequency band signal and a high-frequency band signal, based on a predetermined frequency (operation 2910).

Then the low-frequency band signal obtained in operation 2910 is transformed from the time domain to the frequency domain and then divided in units of sub bands (operation 2920). In operation 2920, the low-frequency band signal is transformed from the time domain to the frequency domain according to a first transformation method, and is transformed again from the time domain to the frequency domain according to a second transformation method that is different from the first transformation method in order to apply the psychoacoustic model to the low-frequency band signal. The signal transformed according to the first transformation method is used in order to encode the low-frequency band signal, and the signal transformed according to the second transformation method is used in order to apply the psychoacoustic model to the low-frequency band signal. The psychoacoustic model means a mathematic model regarding the masking reaction of the human auditory system.

For example, in operation 2920, the low-frequency band signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring.

Next, an important spectral component is selected from each of sub bands of the signal transformed into the frequency domain in operation 2920, the selected component is quantized, the remnant spectral components except the important spectral components are extracted, and then the noise levels of the remnant spectral components are calculated and quantized (operation 2930). Operation 2930 may be performed as illustrated in FIG. 22 or 23.

Next, the high-frequency band signal obtained in operation 2910 is encoded using the low-frequency band signal (operation 2940).

Next, the result of quantizing the parameters in operation 2900, the result of encoding in operation 2930, and the result of encoding in operation 2940 are multiplexed into a bitstream (operation 2950). Here, the result of encoding operation 2930 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

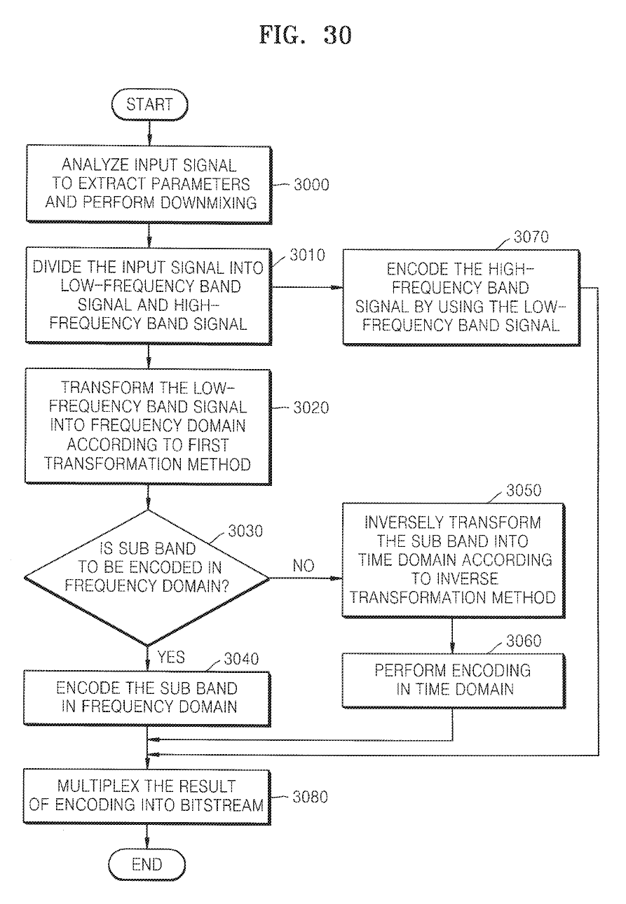

FIG. 30 is a flowchart illustrating an audio and/or speech signal encoding method according to another embodiment of the present general inventive concept. First, if an input signal is a stereo signal, the input signal is analyzed to extract parameters and then is downmixed (operation 3000). The parameters extracted in operation 3000 indicate information needed for a decoding unit to upmix a mono signal received from an encoding unit to a stereo signal. Examples of the parameters include the difference between the energy levels of two channels, or the correlation or coherence between the two channels. Also, the parameters extracted are quantized in operation 3000.

Next, the signal being downmixed in operation 3000 is divided into a low-frequency band signal and a high-frequency band signal, based on a predetermined frequency (operation 3010).

Then the low-frequency band signal obtained in operation 3010 is transformed from the time domain to the frequency domain and then divided in units of sub bands (operation 3020). In operation 3020, the low-frequency band signal is transformed from the time domain to the frequency domain according to a first transformation method, and is transformed again from the time domain to the frequency domain according to a second transformation method that is different from the first transformation method in order to apply the psychoacoustic model to the low-frequency band signal. The signal transformed according to the first transformation method is used in order to encode the low-frequency band signal, and the signal transformed according to the second transformation method is used in order to apply the psychoacoustic model to the low-frequency band signal.

For example, in operation 3020, the low-frequency band signal may be represented with real numbers by transforming the input signal into the frequency domain according to the MDCT as the first transformation method, and be represented with imaginary numbers by transforming the input signal into the frequency domain according to MDST as the second transformation method. Here, the signal represented with real numbers as a result of using MDCT is used for encoding the low-frequency band signal, and the signal represented with imaginary numbers as a result of using MDST is used for applying the psychoacoustic model to the low-frequency band signal. Thus, since phase information of the input signal can be further represented, DFT is performed on the signal corresponding to the time domain and then MDCT coefficients are quantized, thereby preventing a mismatch from occurring. The psychoacoustic model means a mathematic model regarding the masking reaction of the human auditory system.

Next, it is determined whether it is appropriate to encode each of the sub bands of the signal, which was transformed into the frequency domain in operation 3020, in the frequency domain (operation 3030). In other words, in operation 3030, whether each of the sub bands of the signal transformed into the frequency domain is to be encoded in the frequency domain or in the time domain is determined based on a predetermined basis. Also, in operation 3030, an identifier indicating a domain for each of the sub bands that is determined here is quantized.

In operation 3030, either one of or both the signal transformed into the frequency domain in operation 3020 and the low-frequency band signal corresponding to the time domain, which was transformed in operation 3020, may be used in order to determine whether a predetermined sub band is to be encoded in the frequency domain.

If it is determined in operation 3030 that each of the sub bands is to be encoded in the frequency domain, it is encoded in the frequency domain (operation 3040). Operation 3040 may be performed as illustrated in FIG. 22 or 23.

If it is determined in operation 3030 that each of the sub bands is not to be encoded in the frequency domain, it is inversely transformed from the frequency domain to the time domain according to an inverse transformation method of the first transformation method (operation 3050). For example, the inverse transformation method of the first transformation method may be IMDCT.

Operations 3020 and 3050 may be embodied as various transformation methods of receiving a signal represented in the time domain and representing it both in the time domain and the frequency domain. More specifically, the various transformation methods are flexible transformation methods in which the signal represented in the time domain is transformed into the frequency domain and then the temporal resolution of the signal is appropriately controlled in units of frequency bands in order to represent a predetermined one or predetermined ones of sub bands of the signal in the frequency domain. In addition, a signal to which the psychoacoustic model is to be applied using imaginary numbers is generated. An example of such a transformation method is FV-MLT.

Next, the signal being inversely transformed into the time domain in units of sub bands in operation 3050 is encoded in the time domain (operation 3060).

It is possible that, even if it is determined in operation 3030 that a specific sub band is not to be encoded in the frequency domain, a signal of the specific sub band can be encoded in both the frequency domain and the time domain. Thus one or more predetermined sub bands are encoded not only in the time domain but also in the frequency domain. In this case, an identifier indicating that the signal of the predetermined sub band(s) has been encoded both in the time domain and the frequency domain is quantized.

The high-frequency band signal obtained in operation 3010 is encoded using the low-frequency band signal (operation 3070).

Then the parameters quantized in operation 3000, the result of quantizing the identifier indicating a domain in which each of the sub bands has been encoded, the result of encoding in operation 3040, the result of encoding in operation 3060, and information for decoding the high-frequency band signal using the low-frequency band signal are multiplexed into a bitstream (operation 3080). The result of encoding in operation 3080 includes the result of quantizing the important spectral components in operation 2210 and the result of quantizing the remnant spectral components in operation 2220 that are illustrated FIG. 22, or includes the result of encoding in operation 2300, the result of quantizing the important spectral components in operation 2320, and the result of quantizing the remnant spectral components in operation 2330 that are illustrated in FIG. 23.

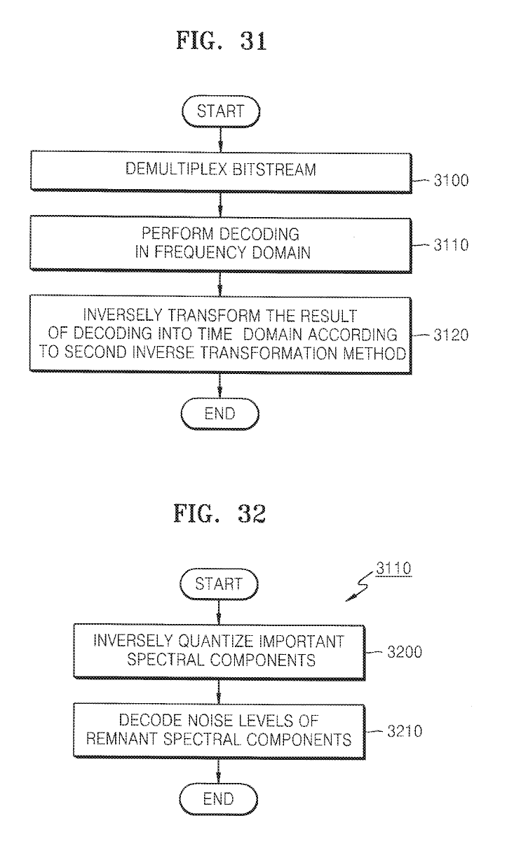

FIG. 31 is a flowchart illustrating an audio and/or speech signal decoding method according to an embodiment of the present general inventive concept. First, a bitstream is received from an encoding terminal and is then demultiplexed (operation 3100). The result of demultiplexing in operation 3100 includes the result of quantizing important spectral components being encoded in the frequency domain by the encoding terminal; the result of quantizing the noise levels of the remnant spectral components; and so on. In addition, the result of demultiplexing may include the result of encoding using a speech tool.

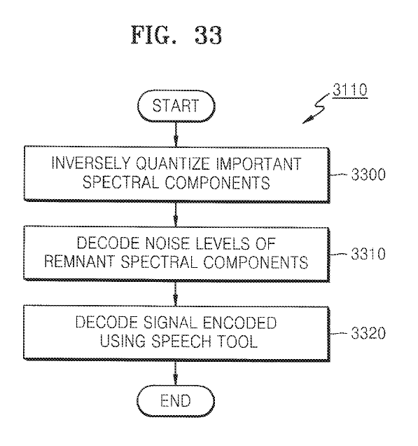

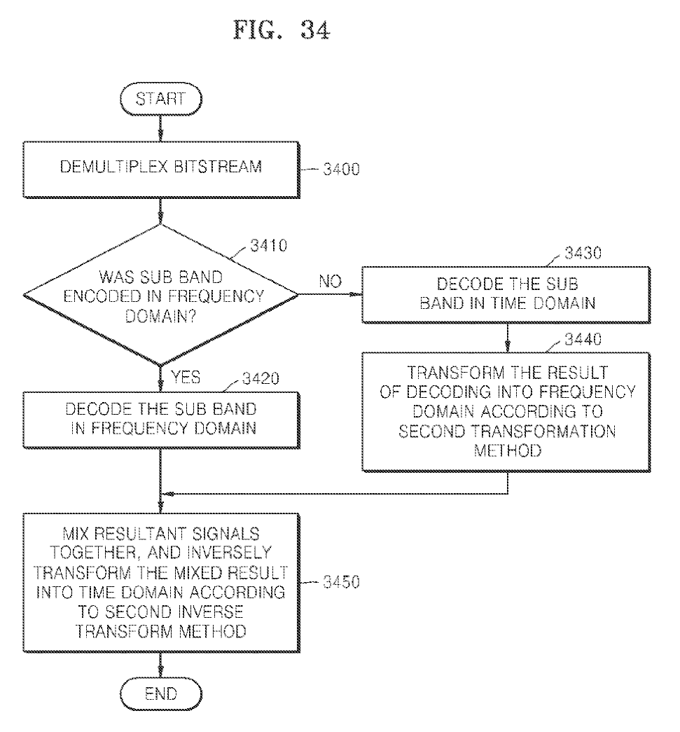

Next, the result of encoding in the frequency domain, which was demultiplexed in operation 3100, is decoded in the frequency domain (operation 3110). More specifically, in operation 3110, important spectral components selected from sub bands, and the noise levels of the remnant spectral components except the important spectral components are decoded. Operation 3110 may be performed as illustrated in FIG. 32 or 33.

FIG. 32 is a flowchart illustrating the operation 3110 of the audio and/or speech signal decoding method of FIG. 31 according to an embodiment of the present general inventive concept.

First, the result of demultiplexing the important spectral components being respectively encoded using different numbers of bits allocated is inversely quantized by applying the psychoacoustic model that removes perceptual redundancy caused by the human auditory characteristics (operation 3200). The psychoacoustic model means a mathematical model regarding the masking reaction of the human auditory system.

Next, the result of demultiplexing the noise levels of the remnant spectral components except the important spectral components being inversely quantized in operation 3200 is decoded (operation 3210). Also, in operation 3210, the decoded noise levels are mixed with the important spectral components decoded in operation 3200.

FIG. 33 is a flowchart illustrating the operation 3110 of the audio and/or speech signal decoding method of FIG. 31 according to another embodiment of the present general inventive concept.

First, the result of demultiplexing the important spectral components being respectively encoded using different numbers of bits allocated is inversely quantized by applying the psychoacoustic model that removes perceptual redundancy caused by the human auditory characteristics (operation 3300).

Next, the result of demultiplexing the noise levels of the remnant spectral components except the important spectral components being inversely quantized in operation 3300 is decoded (operation 3310). Also, in operation 3310, the decoded noise levels are mixed with the important spectral components decoded in operation 3200.

After operation 3310, the result of demultiplexing the result of encoding by the encoding terminal by using the speech tool is decoded (operation 3320). Also, in operation 3320, the result of decoding in operation 3320 is mixed with the result of mixing in operation 3310.

Next, the result of decoding in operation 3110 is inversely transformed from the frequency domain to the time domain according to a second inverse transformation method (operation 3120). Here, the second inversion transformation method is an inverse operation of the above second transformation method. An example of the second inversion transformation method is IMDCT. For example, in operation 3120, the result of mixing in operation 3200 of FIG. 32 is inversely transformed from the frequency domain to the time domain by using IMDCT, and the result of mixing in operation 3320 of FIG. 33 is inversely transformed from the frequency domain to the time domain by using IMDCT.

FIG. 34 is a flowchart illustrating an audio and/or speech signal decoding method according to another embodiment of the present general inventive concept. First, a bitstream is received from an encoding terminal and is then demultiplexed (operation 3400). The result of demultiplexing in operation 3400 includes information regarding a domain in which each of sub bands has been encoded, the result of encoding a predetermined sub band in the frequency domain by the encoding terminal, and the result of encoding a predetermined sub band in the time domain by the encoding terminal.

Here, the result of encoding in the frequency domain by the encoding terminal includes the result of quantizing important spectral components and the result of quantizing the noise levels of the remnant spectral components. In addition, the result of encoding in the frequency domain may include the result of encoding using the speech tool.

Next, the information regarding a domain in which each of the sub bands being demultiplexed in operation 3400 has been encoded, is read in order to determine whether each of the sub bands has been encoded in the frequency domain or the time domain (operation 3410).

If it is determined in operation 3410 that one or more sub bands have been encoded in the frequency domain, the sub bands are decoded in the frequency domain (operation 3420). More specifically, in operation 3420, an important spectral component selected from each of the sub bands is decoded, and the noise levels of the remnant spectral components excluding the important spectral components are decoded. Operation 3420 may be performed as illustrated in FIG. 32 or 33.

If it is determined in operation 3410 that one or more sub bands have been encoded in the time domain, the sub bands are decoded in the time domain (operation 3430).

In a predetermined one or predetermined ones cases, even if a specific sub band is determined to be encoded in the time domain, the specific sub band may have been encoded in both the frequency domain and the time domain. In this case, not only the result of encoding the specific sub band in the time domain but also the result of encoding the specific sub band in the frequency domain are decoded.

Next, the result of decoding in operation 3430 is transformed from the time domain to the frequency domain according to a second transformation method (operation 3440). An example of the second transformation method is MDCT.

Next, the signal of the sub bands decoded in operation 3420 and the signal of the result of transforming in operation 3440 are mixed together and then the mixed result is inversely transformed from the frequency domain to the time domain according to a second inverse transformation method (operation 3450). The second inversion transformation method is an inverse operation of the above second transformation method. An example of the second inversion transformation method is IMDCT.

Operations 3440 and 3450 may be embodied as various transformation methods in which signals being divided into units of predetermined bands and represented in the time domain or the frequency domain are received and transformed into the time domain. An example of such a transformation method is FV-MLT.

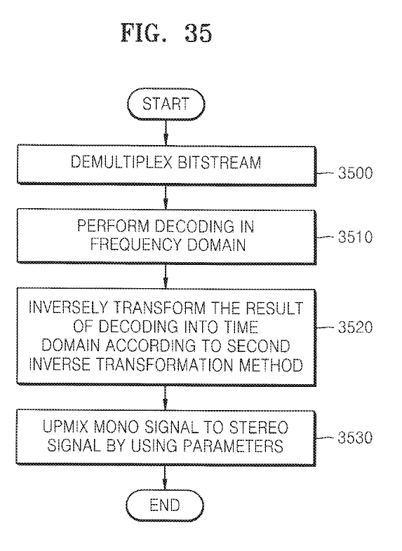

FIG. 35 is a flowchart illustrating an audio and/or speech signal decoding method according to another embodiment of the present general inventive concept. First, a bitstream is received from an encoding terminal and is then demultiplexed (operation 3500). The result of demultiplexing in operation 3500 includes the result of encoding in the frequency domain by the encoding terminal, and parameters for upmixing a mono signal to a stereo signal. Here, the result of encoding in the frequency domain by the encoding terminal includes the result of quantizing important spectral components, and the result of quantizing the noise levels of the remnant spectral components. In addition, the result of encoding in the frequency domain may include the result of encoding using a speech tool.

Next, the result of encoding in the frequency domain, which was demultiplexed in operation 3500, is decoded in the frequency domain (operation 3510). More specifically, in operation 3510, important spectral components selected from sub bands, and the noise levels of the remnant spectral components except the important spectral components are decoded. Operation 3510 may be performed as illustrated in FIG. 32 or 33.

Next, the result of decoding in operation 3510 is inversely transformed from the frequency domain to the time domain according to a second inverse transformation method (operation 3520). Here, the second inversion transformation method is an inverse operation of the above second transformation method. An example of the second inversion transformation method is IMDCT.

A mono signal that is the result of inversely transforming in operation 3520 is upmixed to a stereo signal by using the parameters for upmixing a mono signal to a stereo signal (operation 3530). Examples of the parameters are the difference between the energy levels of two channels, and the correlation or coherence between the two channels.

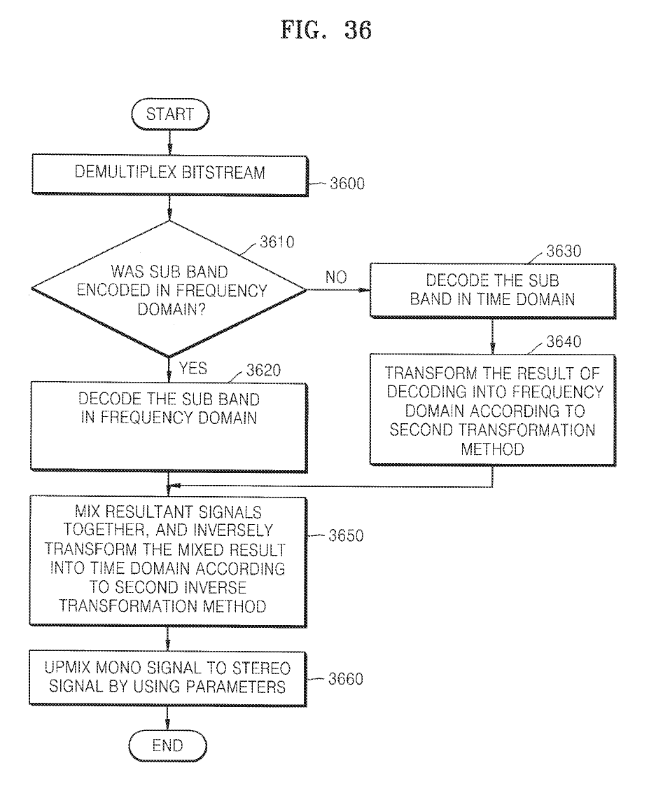

FIG. 36 is a flowchart illustrating an audio and/or speech signal decoding method according to another embodiment of the present general inventive concept. First, a bitstream is received from an encoding terminal and is then demultiplexed (operation 3600). The result of demultiplexing in operation 3600 includes information regarding a domain in which each of sub bands has been encoded, the result of encoding a predetermined sub band in the frequency domain by the encoding terminal, and the result of encoding a predetermined sub band in the time domain by the encoding terminal.

Here, the result of encoding in the frequency domain by the encoding terminal includes the result of quantizing important spectral components and the result of quantizing the noise levels of the remnant spectral components. In addition, the result of encoding in the frequency domain may include the result of encoding using the speech tool.

Next, the information regarding a domain in which each of the sub bands being demultiplexed in operation 3600 has been encoded, is read in order to determine whether each of the sub bands has been encoded in the frequency domain or the time domain (operation 3610).

If it is determined in operation 3610 that one or more sub bands have been encoded in the frequency domain, the sub bands are decoded in the frequency domain (operation 3620).

More specifically, in operation 3620, an important spectral component selected from each of the sub bands is decoded, and the noise levels of the remnant spectral components excluding the important spectral components are decoded. Operation 3620 may be performed as illustrated in FIG. 32 or 33.

If it is determined in operation 3610 that one or more sub bands have been encoded in the time domain, the sub bands are decoded in the time domain (operation 3630).

In a predetermined one or predetermined ones cases, even if a specific sub band is determined to be encoded in the time domain, the specific sub band may have been encoded in both the frequency domain and the time domain. In this case, not only the result of encoding the specific sub band in the time domain but also the result of encoding the specific sub band in the frequency domain are decoded.

Next, the result of decoding in operation 3630 is transformed from the time domain to the frequency domain according to a second transformation method (operation 3640). An example of the second transformation method is MDCT.

Next, the signal of the sub bands decoded in operation 3620 and the signal of the result of transforming in operation 3640 are mixed together and then the mixed result is inversely transformed from the frequency domain to the time domain according to a second inverse transformation method (operation 3650). The second inversion transformation method is an inverse operation of the above second transformation method. An example of the second inversion transformation method is IMDCT.

Operations 3640 and 3650 may be may be embodied as various transformation methods in which signals being divided into units of predetermined bands and represented in the time domain or the frequency domain are received and transformed into the time domain. An example of such a transformation method is FV-MLT.

Thereafter, a mono signal that is the result of inversely transforming in operation 3650 is upmixed to a stereo signal by using the parameters for upmixing a mono signal to a stereo signal (operation 3660). Examples of the parameters are the difference between the energy levels of two channels, and the correlation or coherence between the two channels.

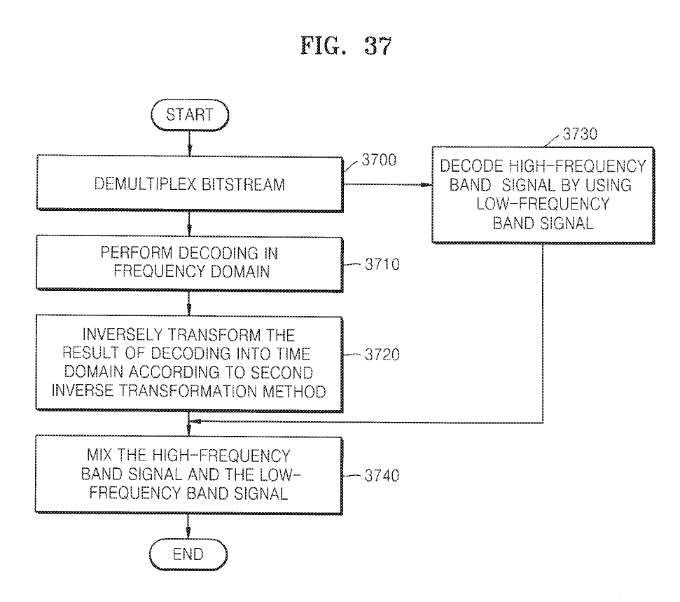

FIG. 37 is a flowchart illustrating an audio and/or speech signal decoding method according to another embodiment of the present general inventive concept. First, a bitstream is received from an encoding terminal and then demultiplexed (operation 3700). The result of demultiplexing in operation 3700 includes the result of encoding in the frequency domain by the encoding terminal, and information for decoding a high-frequency band signal by using a low-frequency band signal. Here, the result of encoding in the frequency domain by the encoding terminal includes the result of quantizing important spectral components and the result of quantizing the noise levels of the remnant spectral components. In addition, the result of encoding in the frequency domain may include the result of encoding using the speech tool.

Next, the result of encoding in the frequency domain, which was demultiplexed in operation 3700, is decoded in the frequency domain (operation 3710). More specifically, in operation 3710, important spectral components selected from sub bands, and the noise levels of the remnant spectral components except the important spectral components are decoded. Operation 3710 may be performed as illustrated in FIG. 32 or 33.

Next, the result of decoding in operation 3710 is inversely transformed from the frequency domain to the time domain according to a second inverse transformation method (operation 3720). Here, the second inversion transformation method is an inverse operation of the above second transformation method. An example of the second inversion transformation method is IMDCT.

Then a high-frequency band signal is decoded using a low-frequency band signal that is the result of inversely transforming in operation 3720, based on the information for decoding a high-frequency band signal by using a low-frequency band signal (operation 3730).

Thereafter the low-frequency band signal being inversely transformed in operation 3720 and the high-frequency band signal decoded in operation 3730 are mixed together (operation 3740).

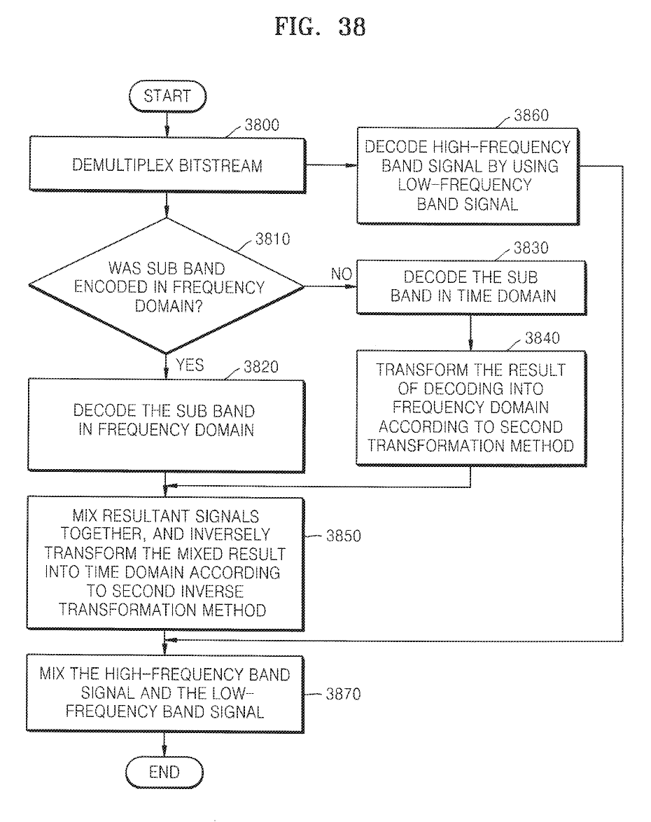

FIG. 38 is a flowchart illustrating an audio and/or speech signal decoding method according to another embodiment of the present general inventive concept. First, a bitstream is received from an encoding terminal and is then demultiplexed (operation 3800). The result of demultiplexing in operation 3800 includes information regarding a domain in which each of sub bands has been encoded, the result of encoding a predetermined sub band in the frequency domain by the encoding terminal, and the result of encoding a predetermined sub band in the time domain by the encoding terminal.

Here, the result of encoding in the frequency domain by the encoding terminal includes the result of quantizing important spectral components and the result of quantizing the noise levels of the remnant spectral components. In addition, the result of encoding in the frequency domain may include the result of encoding using the speech tool.

Next, the information regarding a domain in which each of the sub bands being demultiplexed in operation 3800 has been encoded, is read in order to determine whether each of the sub bands has been encoded in the frequency domain or the time domain (operation 3810).

If it is determined in operation 3810 that one or more sub bands have been encoded in the frequency domain, the sub bands are decoded in the frequency domain (operation 3820). More specifically, in operation 3820, an important spectral component selected from each of the sub bands is decoded, and the noise levels of the remnant spectral components excluding the important spectral components are decoded. Operation 3820 may be performed as illustrated in FIG. 32 or 33.

If it is determined in operation 3810 that one or more sub bands have been encoded in the time domain, the sub bands are decoded in the time domain (operation 3830).

In a predetermined one or predetermined ones cases, even if a specific sub band is determined to be encoded in the time domain, the specific sub band may have been encoded in both the frequency domain and the time domain. In this case, not only the result of encoding the specific sub band in the time domain but also the result of encoding the specific sub band in the frequency domain are decoded.

Next, the result of decoding in operation 3830 is transformed from the time domain to the frequency domain according to a second transformation method (operation 3840). An example of the second transformation method is MDCT.

Next, the signal of the sub bands decoded in operation 3820 and the signal of the result of transforming in operation 3840 are mixed together and then the mixed result is inversely transformed from the frequency domain to the time domain according to a second inverse transformation method (operation 3850). The second inversion transformation method is an inverse operation of the above second transformation method. An example of the second inversion transformation method is IMDCT.

Operations 3840 and 3850 may be may be embodied as various transformation methods in which signals being divided into units of predetermined bands and represented in the time domain or the frequency domain are received and transformed into the time domain. An example of such a transformation method is FV-MLT.

Then a high-frequency band signal is decoded using a low-frequency band signal demultiplexed in operation 3800, based on the information for decoding a high-frequency band signal by using a low-frequency band signal (operation 3860).

Thereafter the low-frequency band signal being inversely transformed in operation 3850 and the high-frequency band signal decoded in operation 3860 are mixed together (operation 3870).

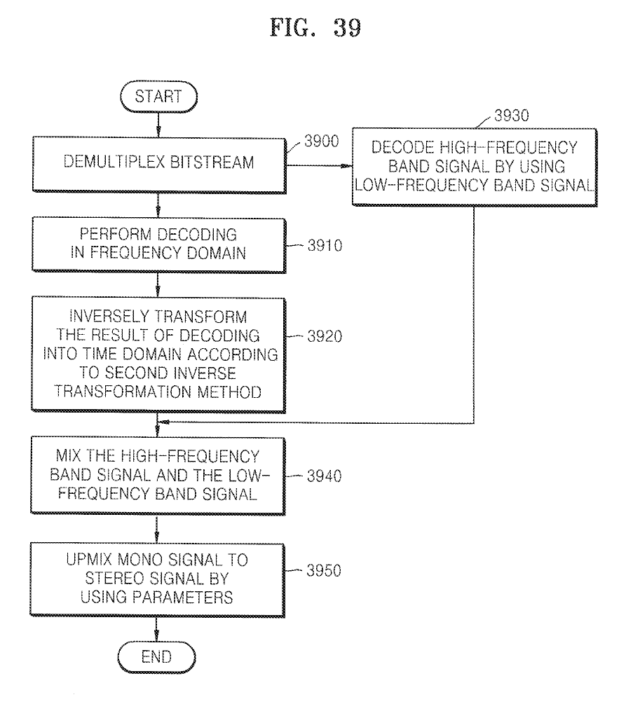

FIG. 39 is a flowchart illustrating an audio and/or speech signal decoding method according to another embodiment of the present general inventive concept. First, a bitstream is received from an encoding terminal and is then demultiplexed (operation 3900). The result of demultiplexing in operation 3900 includes the result of encoding in the frequency domain by the encoding terminal, information for decoding a high-frequency band signal by using a low-frequency band signal, and parameters for upmixing a mono signal to a stereo signal. Here, the result of encoding in the frequency domain by the encoding terminal includes the result of quantizing important spectral components, and the result of quantizing the noise levels of the remnant spectral components. In addition, the result of encoding in the frequency domain may include the result of encoding using a speech tool.

Next, the result of demultiplexing in operation 3900 is decoded in the frequency domain (operation 3910). More specifically, in operation 3910, important spectral components selected from sub bands, and the noise levels of the remnant spectral components except the important spectral components are decoded. Operation 3910 may be performed as illustrated in FIG. 32 or 33.

Next, the result of decoding in operation 3910 is inversely transformed from the frequency domain to the time domain according to a second inverse transformation method (operation 3920). Here, the second inversion transformation method is an inverse operation of the above second transformation method. An example of the second inversion transformation method is IMDCT.

Then a high-frequency band signal is decoded using a low-frequency band signal demultiplexed in operation 3900, based on the information for decoding a high-frequency band signal by using a low-frequency band signal (operation 3930).

Thereafter the low-frequency band signal being inversely transformed in operation 3920 and the high-frequency band signal decoded in operation 3930 are mixed together (operation 3940).

Next, a mono signal that is the result of mixing in operation 3940 is upmixed to a stereo signal by using the parameters for upmixing a mono signal to a stereo signal (operation 3950). Examples of the parameters are the difference between the energy levels of two channels, and the correlation or coherence between the two channels.

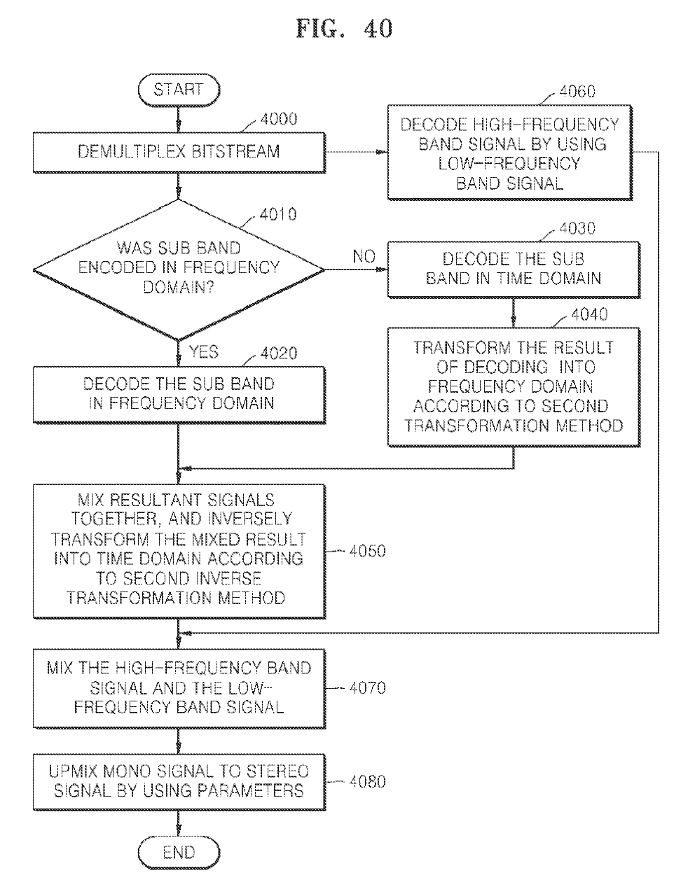

FIG. 40 is a flowchart illustrating an audio and/or speech signal decoding method according to another embodiment of the present general inventive concept. First, a bitstream is received from an encoding terminal and is then demultiplexed (operation 4000). The result of demultiplexing in operation 4000 includes information regarding a domain in which each of sub bands has been encoded, the result of encoding a predetermined sub band in the frequency domain by the encoding terminal, and the result of encoding a predetermined sub band in the time domain by the encoding terminal.

Here, the result of encoding in the frequency domain by the encoding terminal includes the result of quantizing important spectral components and the result of quantizing the noise levels of the remnant spectral components. In addition, the result of encoding in the frequency domain may include the result of encoding using the speech tool.

Next, the information regarding a domain in which each of the sub bands being demultiplexed in operation 4000 has been encoded, is read in order to determine whether each of the sub bands has been encoded in the frequency domain or the time domain (operation 4010).

If it is determined in operation 4010 that one or more sub bands have been encoded in the frequency domain, the sub bands are decoded in the frequency domain (operation 4020). More specifically, in operation 4020, an important spectral component selected from each of the sub bands is decoded, and the noise levels of the remnant spectral components excluding the important spectral components are decoded. Operation 4020 may be performed as illustrated in FIG. 32 or 33.

If it is determined in operation 4010 that one or more sub bands have been encoded in the time domain, the sub bands are decoded in the time domain (operation 4030).

In a predetermined one or predetermined ones cases, even if a specific sub band is determined to be encoded in the time domain, the specific sub band may have been encoded in both the frequency domain and the time domain. In this case, not only the result of encoding the specific sub band in the time domain but also the result of encoding the specific sub band in the frequency domain are decoded.

Next, the result of decoding in operation 4030 is transformed from the time domain to the frequency domain according to a second transformation method (operation 4040). An example of the second transformation method is MDCT.

Next, the signal of the sub bands decoded in operation 4020 and the signal of the result of transforming in operation 4040 are mixed together and then the mixed result is inversely transformed from the frequency domain to the time domain according to a second inverse transformation method (operation 4050). The second inversion transformation method is an inverse operation of the above second transformation method. An example of the second inversion transformation method is IMDCT.

Operations 4040 and 4050 may be embodied as various transformation methods in which signals being divided into units of predetermined bands and represented in the time domain or the frequency domain are received and transformed into the time domain. An example of such a transformation method is FV-MLT.

Then a high-frequency band signal is decoded using a low-frequency band signal that is the result of demultiplexing in operation 4000, based on the information for decoding a high-frequency band signal by using a low-frequency band signal (operation 4060).

Next, the low-frequency band signal being inversely transformed in operation 4050 and the high-frequency band signal decoded in operation 4060 are mixed together (operation 4070).

Thereafter a mono signal that is the result of inversely transforming in operation 4050 is upmixed to a stereo signal by using the parameters for upmixing a mono signal to a stereo signal (operation 4080). Examples of the parameters are the difference between the energy levels of two channels, and the correlation or coherence between the two channels.

The present general inventive concept can be embodied as computer readable code in a computer readable medium, wherein the computer includes apparatuses with information processing functions. The computer readable medium may be any recording apparatus capable of storing data as a program that is read by a computer system, e.g., a read-only memory (ROM), a random access memory (RAM), a compact disc (CD)-ROM, a magnetic tape, a floppy disk, an optical data storage device, and so on.

The audio and/or speech signal encoding and decoding method and apparatus according to the present general inventive concept are capable of effectively encoding and decoding all a speech signal, an audio signal, and a mixed signal thereof. Also, encoding and decoding can be performed using a small number of bits, thereby improving the quality of sound. A single codec can be used to perform the encoding and/or decoding operations of the above-described audio and/or speech signal encoding and decoding method and apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claims is:

1. A method of decoding a signal of audio and/or speech, the method comprising:
determining whether the signal is encoded in a frequency domain or a time domain based on mode information from a bitstream;
decoding, performed by using at least one processing device, the signal in the frequency domain, if it is determined that the signal is encoded in the frequency domain;
decoding, performed by using at least one processing device, the signal in the time domain, if it is determined that the signal is encoded in the time domain; and
upmixing a mono signal including the signal decoded in either the frequency domain or the time domain and a generated high frequency band signal to a stereo signal by using parameters for upmixing the mono signal to the stereo signal, in a structure of performing decoding of the signal through switching between the frequency domain and the time domain.

2. The method of claim 1, wherein in the determined domain, the signal is to be represented in predetermined units.

3. The method of claim 1, wherein:
the signal comprises a low-frequency band signal.

4. The method of claim 1, wherein the decoding of the signal in the determined domain comprises:
decoding one or more spectral components for one or more units that are determined as having been encoded in the frequency domain; and
decoding remnant spectral components excluding the decoded spectral components.

5. The method of claim 1 further comprising:
transforming the mono signal including the signal decoded in either the frequency domain or the time domain to a representation in a time-frequency domain,
wherein the upmixing the mono signal comprises upmixing the mono signal, represented in the time-frequency domain, and the generated high frequency band signal to the stereo signal.

6. An apparatus to decode a signal of audio and/or speech, the apparatus comprising:
a demultiplexing unit to determine whether the signal is encoded in a frequency domain or a time domain based on mode information from a bitstream;
a first decoding unit, implemented by using at least one processing device, to decode the signal in the frequency domain, if it is determined that the signal is encoded in the frequency domain;
a second decoding unit, implemented by using at least one processing device, to decode the signal in the time domain, if it is determined that the signal is encoded in the time domain; and
an upmixer to upmix a mono signal including the signal decoded in the determined domain and a generated high-frequency band signal to a stereo signal by using parameters for upmixing the mono signal to the stereo signal, in a structure of performing decoding of the signal through switching between the frequency domain and the time domain.

7. The apparatus of claim 6, further comprising:
a domain transformation unit to transform the mono signal including the signal decoded in either the frequency domain or the time domain, to a representation in a time-frequency domain,
wherein the upmixer upmixes the mono signal, represented in the time-frequency domain, and the generated high frequency band signal to the stereo signal.

8. A method of decoding a signal of audio and/or speech, the method comprising:
determining whether the signal is encoded in a frequency domain or a time domain based on mode information from a bitstream;
decoding, performed by using at least one processing device, the signal in the frequency domain, if it is determined that the signal is encoded in the frequency domain;
decoding, performed by using at least one processing device, the signal in the time domain, if it is determined that the signal is encoded in the time domain;
generating a high band signal by using the signal decoded in either the frequency domain or the time domain and additional information; and
upmixing a mono signal including the signal decoded in either the frequency domain or the time domain and a generated high band signal to a stereo signal by using parameters for upmixing the mono signal to the stereo signal, in a structure of performing decoding of the signal through switching between the frequency domain and the time domain.

9. The method of claim 8, wherein:
the generating the high band comprises transforming the mono signal including the signal decoded in either the frequency domain or the time domain to a representation in a time-frequency domain, and
the upmixing the mono signal comprises upmixing the mono signal, represented in the time-frequency domain, and the generated high frequency band signal to the stereo signal.
